(19) United States
(12) Patent Application Publication
(10) Pub. No.: US 2019/0361408 A1
(43) Pub. Date: Nov. 28, 2019

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/406,082

(22) Filed: May 8, 2019

(30) Foreign Application Priority Data
May 22, 2018 (JP) 2018-098258

(51) Int. Cl. G05B 13/02; G08B 21/18

(52) U.S. Cl. CPC G05B 13/028; H04L 51/02; G08B 21/18

(57) ABSTRACT

An information processing apparatus includes a controller. When an operation instruction directed to a device is given by a user, the controller sends the operation instruction to the device from an operation assistant capable of controlling the device among multiple operation assistants included in the information processing apparatus.

### CROSS-REFERENCE TO RELATED APPLICATIONS

This application is based on and claims priority under 35 USC 119 from Japanese Patent Application No. 2018-098258 filed May 22, 2018.

### BACKGROUND

### (i) Technical Field

The present disclosure relates to an information processing apparatus and a non-transitory computer readable medium.

### (ii) Related Art

Some devices include operation assistants. Operation assistants respond to questions from users or perform tasks, for example.

Japanese Unexamined Patent Application Publication (Translation of PCT Application) No. 2002-513185 describes an intelligent assistant that accesses only Internet sites that are authorized to gather information of interest to a user.

Japanese Unexamined Patent Application Publication No. 2002-41276 describes a personified assistant that makes reactions based on speech synthesis and animations.

### SUMMARY

In some cases, a device may include a plurality of operation assistants.

Aspects of non-limiting embodiments of the present disclosure relate to an improvement in operability when a device includes a plurality of operation assistants.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a controller. When an operation instruction directed to a device is given by a user, the controller sends the operation instruction to the device from an operation assistant capable of controlling the device among a plurality of operation assistants included in the information processing apparatus.

### BRIEF DESCRIPTION OF THE DRAWINGS

Exemplary embodiments of the present disclosure will be described in detail based on the following figures, wherein:

FIG. 1 is a block diagram illustrating a configuration of an information processing system according to a first exemplary embodiment of the present disclosure;

FIG. 2 is a block diagram illustrating a configuration of a device;

FIG. 3 is a perspective view of a relay;

FIG. 4 illustrates a function management table;

FIG. 5 illustrates a process according to Example 1-1;

FIG. 6 illustrates a screen according to Example 1-1;

FIGS. 7A to 7C illustrate a process according to Example 1-2;

FIGS. 8A to 8C illustrate a process according to Example 1-3;

FIG. 9 illustrates a process according to Example 1-4;

FIG. 10 illustrates a screen according to Example 1-4;

FIG. 11 illustrates a process according to Example 1-5;

FIG. 12 is a table illustrating functions and devices controllable by operation assistants;

FIG. 13 illustrates a process according to Example 1-5;

FIG. 14 illustrates a process according to Example 1-5;

FIGS. 15A and 15B illustrate a process according to Example 1-6;

FIGS. 16A and 16B illustrate a process according to Example 1-7;

FIG. 17 illustrates a process according to Example 2-1;

FIG. 18 illustrates a process according to Example 2-2;

FIG. 19 illustrates a screen according to Example 2-2;

FIG. 20 illustrates a process according to Example 2-3;

FIG. 21 illustrates a process according to Example 2-4;

FIG. 22 illustrates a process according to Example 2-6;

FIG. 23 illustrates a process according to Example 2-7;

FIG. 24 illustrates a process according to Example 2-7;

FIG. 25 illustrates a process according to a third exemplary embodiment;

FIG. 26 is a block diagram illustrating a configuration of an information processing system according to a fourth exemplary embodiment;

FIG. 27 illustrates a process according to Example 4-1;

FIG. 28 illustrates a process according to Example 4-2;

FIG. 29 illustrates a process according to Example 4-3;

FIG. 30 illustrates a screen according to Example 4-5; and

FIG. 31 illustrates a process according to Example 4-5.

### DETAILED DESCRIPTION

### First Exemplary Embodiment

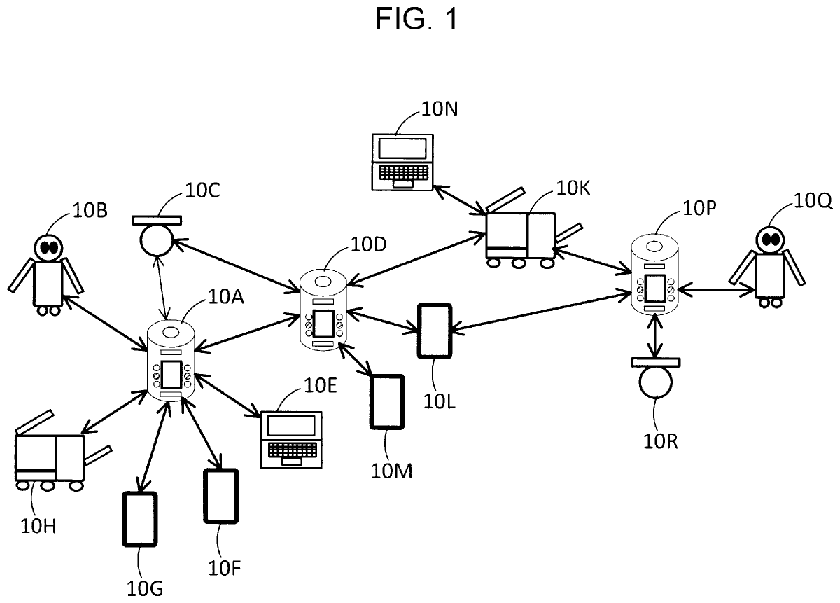

An information processing system according to a first exemplary embodiment of the present disclosure will be described with reference to FIG. 1. FIG. 1 illustrates an example of the information processing system according to the first exemplary embodiment.

The information processing system according to the first exemplary embodiment includes a plurality of devices. In the example illustrated in FIG. 1, the information processing system includes devices 10A to 10R. The devices 10A to 10R illustrated in FIG. 1 are examples, and the information processing system may include devices other than those illustrated in FIG. 1. The information processing system may also include a server. In the following, the devices 10A to 10R are referred to collectively as the “devices 10” and individually as the “device 10” unless the devices 10A to 10R need to be distinguished from each other.

Each of the devices 10 has a function of communicating with another device 10. Each of the devices 10 may communicate with another device 10 via wireless communication or wired communication. For example, each of the devices 10 may communicate with another device 10 via a communication path such as the Internet or any other network, communicate directly with another device 10, communicate with another device 10 via a relay that functions as a hub, or communicate with another device 10 via a cloud infrastructure or a server. Each of the devices 10 may be a so-called Internet of Things (IoT) device.

The devices 10 are each a device having a function. Examples of the devices 10 include an image forming device having an image forming function (such as a scanning function, a printing function, a copying function, or a facsimile function), a personal computer (PC), a tablet PC, a smartphone, a mobile phone, a robot (such as a humanoid robot, a non-humanoid, animal-shaped robot, or any other type of robot), a projector, a display device such as a liquid crystal display, a recording device, a reproduction device, an imaging device such as a camera, a refrigerator, a rice cooker, a microwave oven, a coffee maker, a vacuum cleaner, a washing machine, an air-conditioner, a lighting device, a timepiece, a security surveillance camera, a motor vehicle, a two-wheeled vehicle, an aircraft (e.g., an unmanned aerial vehicle (called a drone)), a game console, and various types of sensing devices (such as a temperature sensor, a humidity sensor, a voltage sensor, and an electric current sensor). The devices 10 may be each a device that outputs information to a user (such as an image forming device or a PC) or a device that does not output information to a user (such as a sensing device). A plurality of devices 10 that execute a collaborative function described below may be all devices that output information to users, or some of them may be devices that output information to users and the other devices 10 may be devices that do not output information to users; otherwise, all of them may be devices that do not output information to users. The concept of the device 10 may include general devices. For example, an information device, a video device, an audio device, and other devices may be included in the concept of the device 10.

Each of the devices 10 may execute a standalone function or work in collaboration with any other device 10 to execute a collaborative function. The standalone function is a function executable using a single device 10, for example. The collaborative function is a function executable using a plurality of devices 10, for example. In the standalone function and the collaborative function, for example, hardware or software included in the devices 10 is used. Each of the devices 10, when not working in collaboration with any other device 10, may independently receive an instruction from a user and execute a standalone function. It is to be understood that the information processing system includes a device 10 (e.g., a sensing device) that executes a function without receiving an instruction from a user.

The collaborative function will now be described. All of the portions of a device 10, a specific portion of the device 10, a specific function of software, an aggregate function including a plurality of functions, or the like may be used for a collaborative function. For example, when each portion of a device 10 is assigned a function, a collaborative function may be a function that uses the portion of the device 10. A specific example will be described. A multifunction device having a plurality of image forming functions includes a main body, which is assigned a printing function, a reader (e.g., a portion corresponding to a document cover, a document glass, and an automatic document feeder), which is assigned a scanning function, and a post-processing device, which is assigned a post-processing function (such as a stapling function). In this case, the main body, the reader, and the post-processing device of the multifunction device may be used for a collaborative function. Alternatively, as software, an aggregate function that is a block-by-block collection of functions, such as Robotics Process Automation (RPA), may be used for a collaborative function. When software has a plurality of functions, a collaborative function may be a function that uses some of the plurality of functions. The aggregate function is made up of a plurality of functions, and the plurality of functions are simultaneously or sequentially executed to perform a process achieved by the aggregate function. Alternatively, a collaborative function may be a function that uses only hardware, only software, or both hardware and software.

A collaborative function may be a function rendered executable by causing a plurality of devices 10 of different types to work in collaboration or may be a function rendered executable by causing a plurality of devices 10 of an identical type to work in collaboration. A collaborative function may be a function that is not available before a plurality of devices 10 work in collaboration. For example, a device 10 (printer) having the printing function and a device 10 (scanner) having the scanning function are caused to work in collaboration to render a collaborative function, namely, the copying function, executable. That is, the printing function and the scanning function are caused to work in collaboration to render the copying function executable.

The concept of a collaborative function may include a composite function in which a plurality of devices 10 are caused to work in collaboration to render a new function executable. For example, a plurality of displays may be combined to achieve an enhanced display function as a composite function. As another example, a television set and a recorder may be combined to achieve a recording function as a composite function. The recording function may be a function of, for example, recording an image being displayed on the television set. A plurality of cameras may be combined to achieve an imaging area extension function as a composite function. The imaging area extension function is a function of, for example, capturing images with the respective imaging areas of the cameras being joined together. A telephone may be combined with a translation machine or translation software to achieve a telephone conversation translation function (a function of translating conversations over the telephone) as a composite function. Accordingly, the concept of a collaborative function may include a function rendered executable by causing a plurality of devices 10 or pieces of software of an identical type to work in collaboration, and a function rendered executable by causing a plurality of devices 10 or pieces of software of different types to work in collaboration.

Alternatively, a plurality of devices 10 may establish a connected home (a system that interconnects devices 10 such as household electrical appliances via a network by using IoT technology), and the connected home may use a collaborative function. In this case, the devices 10 may be interconnected via a specific server or may be interconnected without the intervention of a specific server.

Alternatively, a plurality of devices 10 may work in collaboration by using IFTTT (if this, then that) to execute a collaborative function. That is, when an event in which the content of a collaborative function is a trigger occurs in a certain device 10, another device 10 may execute an action (processing). For example, a collaborative function may be executed such that detection of the opening of a door by a sensor, which is a device 10, triggers an action of turning on another device 10 such as a lighting device. A function executed such that an action executed by a certain device 10 triggers another device 10 to execute another action may also be included in the concept of a collaborative function. Alternatively, a function for enabling a plurality of web services to work in collaboration, or application programming interface (API) collaboration that enables a plurality of systems, services, and so forth to work in collaboration by using an API may be included in the concept of a collaborative function.

In the example illustrated in FIG. 1, the devices 10A, 10D, and 10P are relays. The devices 10B and 10Q are robots. The devices 10C and 10R are cameras. The devices 10E and 10N are PCs. The devices 10F, 10G, 10L, and 10M are smartphones, which are an example of terminal devices. The devices 10H and 10K are multifunction devices having image forming functions.

For example, a relay may control another device 10 connected to the relay (e.g., hardware included in the other device 10 or software installed in the other device 10). The relay may acquire various kinds of information by using the Internet or the like. The relay may function as a server or may be configured to, for example, manage data or user information. The relay may be a so-called smart speaker (a device having a communication function and a speaker function) or a device having the communication function but not having the speaker function. The relay may be placed indoor (such as on a floor, a ceiling, or a table in a room) or may be placed outdoor. The relay may be a movable device (e.g., a self-propelled device).

A terminal device is a device such as a PC, a tablet PC, a smartphone, or a mobile phone. The terminal device may be a wearable terminal such as a wristwatch-type terminal, a wristband-type terminal, a glasses-type terminal, a ring-type terminal, a contact-lens-type terminal, a body-embedded terminal, or an in-ear wearable terminal. The terminal device may include a display device such as a flexible display. Examples of the flexible display include an organic electroluminescent (EL) display (a flexible organic EL display), an electronic paper display, and a flexible liquid crystal display. A flexible display that adopts any other display method may be used. A flexible display is a display having a flexible, deformable display portion such that the display can be bent, folded, rolled, twisted, and/or stretched, for example. The terminal device may be entirely formed as a flexible display or may be divided functionally or physically into a flexible display and other elements.

For example, each of the devices 10A to 10R is configured to independently execute the standalone function in accordance with an instruction from a user or automatically regardless of whether an instruction is given from a user. For example, each of the devices 10A, 10D, and 10P serving as relays acquires various kinds of information and provides the information to a user in accordance with an instruction from the user or automatically regardless of whether the instruction is given from the user. Each of the devices 10B and 10Q serving as robots performs various tasks in accordance with an instruction from a user or automatically regardless of whether an instruction is given from a user. Each of the devices 10C and 10R serving as cameras captures an image and generates image data (moving image data or still image data) in accordance with an instruction from a user or automatically regardless of whether an instruction is given from a user. Each of the devices 10E and 10N serving as PCs performs various types of processing in accordance with an instruction from a user or automatically regardless of whether an instruction is given from a user. Each of the devices 10F, 10G, 10L, and 10M serving as smartphones performs various types of processing in accordance with an instruction from a user or automatically regardless of whether an instruction is given from a user. Each of the devices 10H and 10K serving as multifunction devices performs an image forming process in accordance with an instruction from a user or automatically regardless of whether an instruction is given from a user.

In addition, each of the devices 10 may execute a collaborative function set therein. For example, setting information indicating the content of a collaborative function is stored in devices 10 that are used for the collaborative function, and each of the devices 10 works in collaboration with the other devices 10 to execute the collaborative function indicated by the stored setting information.

Each of the devices 10 includes one or more operation assistants (or personal assistants) for assisting a user. An operation assistant is configured to, for example, control a device 10 including the operation assistant or to control any other device 10. The operation assistant may control hardware constituting the device 10 or control software installed in the device 10. For example, the operation assistant analyzes an instruction given from a user and controls the device 10 in accordance with the instruction to control the execution of a function designated by the user.

The operation assistant may also have a function of interacting with a user. That is, the operation assistant may function as an interaction partner of a user. For example, the operation assistant analyzes an utterance produced by a user, generates a response based on the result of the analysis, and provides the response to the user.

When a user provides an instruction or utterance to an operation assistant via voice input, text input, or any other method, for example, the operation assistant applies natural language processing such as morphological analysis to the input information to analyze the instruction or utterance.

An operation assistant is implemented by, for example, executing an operation assistant program. The operation assistant program is installed in each of the devices 10. It is to be understood that the operation assistant program may be installed in an external device such as a server and the function of the operation assistant may be provided from the server to a device 10.

An operation assistant may be implemented by artificial intelligence (AI). For example, an operation assistant may have an AI-based learning function and have an ability to make a human-like decision by using the learning function. Alternatively, neural-network-based deep learning may be used, or reinforcement learning or the like for partially reinforcing a learning area may be used. Any other technique such as genetic algorithm, cluster analysis, self-organizing map, or ensemble learning may be used. It is to be understood that any other AI-related technique may be used. An operation assistant may function as a chatbot serving as an automatic response AI (an automatic conversational program that utilizes AI).

An operation assistant may operate in accordance with an instruction from a user associated with a user account that is currently logged into the operation assistant.

In the first exemplary embodiment, when a certain device 10 (the requesting device 10) transmits information indicating a connection request to another device 10 (the requested device 10), an operation assistant included in the other device 10 (the requested device 10) is set as a slave operation assistant and is caused to operate as a slave operation assistant. The slave operation assistant is controlled in accordance with an instruction from a different operation assistant other than the slave operation assistant.

In some cases, for example, when a device 10 has a standalone function or a collaborative function, when a device 10 is used to execute a standalone function or a collaborative function, when a user makes a connection request, or when another device 10 is used through a certain device 10, the certain device 10 transmits information indicating a connection request to the other device 10. In this case, an operation assistant included in the other device 10, which is the requested device, is set as a slave operation assistant. It is to be understood that, when any other event occurs, information indicating a connection request may be transmitted from a certain device 10 to another device 10.

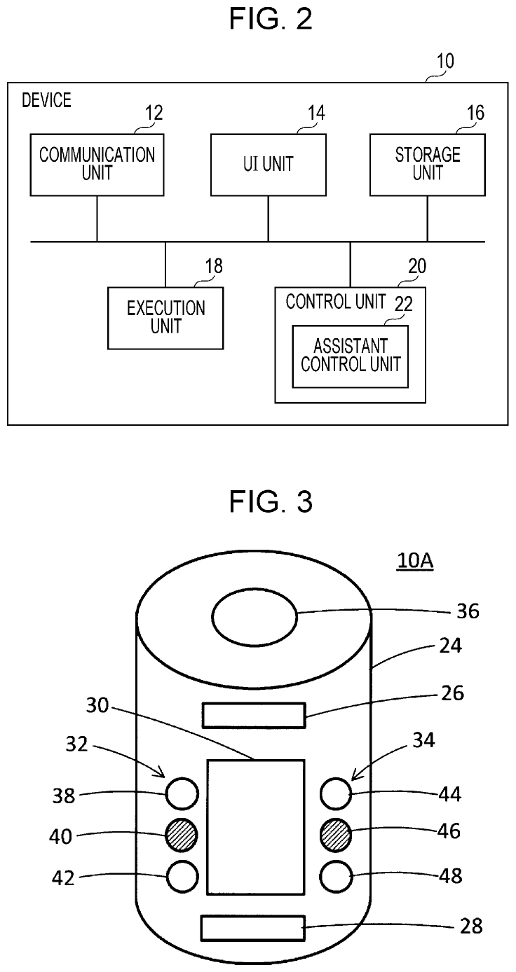

The following describes the configuration of each of the devices 10 in detail with reference to FIG. 2. FIG. 2 illustrates an example configuration of each of the devices 10. FIG. 2 illustrates a configuration that the devices 10 have in common, but does not illustrate a configuration specific to each of the devices 10.

A communication unit 12 is a communication interface and has a function of transmitting data to another device and a function of receiving data from another device. The communication unit 12 may be a communication interface having a wireless communication function or may be a communication interface having a wired communication function. The communication unit 12 supports one or more communication schemes, for example, and may communicate with a communication partner in accordance with a communication scheme suitable for the communication partner (i.e., a communication scheme supported by the communication partner). Examples of the communication scheme include schemes for infrared communication, visible light communication, Wi-Fi (registered trademark) communication, and short-range wireless communication such as near field communication (NFC). Examples of the short-range wireless communication include Felica (registered trademark), Bluetooth (registered trademark), and radio frequency identifier (RFID) based communication. The communication unit 12 may support the fifth generation mobile communication system (5G). It is to be understood that wireless communication based on any other scheme may be used as short-range wireless communication. The communication unit 12 may switch between communication schemes or frequency bands in accordance with the communication partner or may switch between communication schemes or frequency bands in accordance with the surrounding conditions. The frequency bands may include, for example, 2.4 GHz and 5 GHz.

A user interface (UI) unit 14 includes a display unit and an operation unit. The display unit is a display device such as a liquid crystal display. The display unit may be a flexible display. The operation unit is an input device including, for example, a touch panel and a keyboard. The UI unit 14 may be a user interface serving as both a display unit and an operation unit (e.g., a user interface including a touch display or a device having a display on which a keyboard or the like is electronically displayed). The UI unit 14 may include an audio collection unit such as a microphone or an audio generation unit such as a speaker. In this case, information may be input to the device 10 via voice input, or information may be output via audio. Note that the information processing system may include a device 10 that does not include the UI unit 14. For example, a sensing device that does not output information to a user may not include the UI unit 14.

A storage unit 16 is a storage device such as a hard disk or a memory (e.g., a solid-state drive (SSD)). The storage unit 16 stores, for example, various types of data, various programs, and so forth. The programs include, for example, an operating system (OS), one or more operation assistant programs, and various application programs. In some devices 10, the storage unit 16 stores no OS or application program. The storage unit 16 may store device address information indicating the addresses (such as Internet protocol (IP) addresses or media access control (MAC) addresses) of the other devices 10, server address information indicating the address (such as the IP address or MAC address) of the server, and so forth.

An execution unit 18 is configured to execute a function. For example, when the device 10 is an image forming device, the execution unit 18 executes an image forming function such as the scanning function, the printing function, or the copying function. When the device 10 is a robot, the execution unit 18 executes a function of a robot (such as a moving function or a lifting function). When the device 10 is a camera, the execution unit 18 executes an image capturing function.

A control unit 20 is configured to control the operation of each unit of the device 10. For example, the control unit 20 performs operations such as executing a program, controlling communication performed by the communication unit 12, controlling notification of information using the UI unit 14 (such as displaying information or outputting audio), acceptance of information input to the device 10 using the UI unit 14, writing information to the storage unit 16, reading information from the storage unit 16, and controlling the execution unit 18. The control unit 20 includes an assistant control unit 22.

In the first exemplary embodiment, the assistant control unit 22 is configured to set an operation assistant as a master operation assistant or a slave operation assistant in accordance with a connection between the devices 10 to cause the operation assistant to operate as a master operation assistant or a slave operation assistant. The assistant control unit 22 may set an operation assistant included in the device 10 including the assistant control unit 22 as a master operation assistant or a slave operation assistant or may set an operation assistant included in any other device 10 as a master operation assistant or a slave operation assistant. As described above, the slave operation assistant is controlled in accordance with an instruction from a different operation assistant other than the slave operation assistant. The master operation assistant corresponds to an example of the different operation assistant.

The following describes the outer appearance of a relay in detail with reference to FIG. 3. FIG. 3 is a perspective view of a relay. As an example, FIG. 3 illustrates the device 10A serving as a relay. The devices 10F and 10P may also have a configuration similar to that of the device 10A or may have a different configuration.

The device 10A is a so-called smart speaker and has a communication function and a voice assistant function. The device 10A includes a substantially cylindrical main body 24. The main body 24 includes, on a side surface thereof, a microphone 26, a speaker 28, a display unit 30, and light-emitting units 32 and 34. The main body 24 further includes a sensor 36 on a top surface thereof. The shape of the main body 24 is not limited to that illustrated in FIG. 3. The main body 24 may have any shape so long as the microphone 26 and the speaker 28 are included in the relay. The microphone 26, the speaker 28, the display unit 30, the light-emitting units 32 and 34, and the sensor 36 may be disposed at positions other than the positions illustrated in FIG. 3.

The microphone 26 functions as an audio collection device that collects sounds around the device 10A. For example, the user's voice is picked up by the microphone 26.

When the user is interacting with an operation assistant, an utterance produced by the operation assistant is output as speech from the speaker 28. Any other type of audio such as music, the audio of a television program, or the audio of a radio program may be output from the speaker 28.

The display unit 30 is a display device. The display unit 30 may be a user interface (such as a touch panel) serving also as an operation unit.

The light-emitting unit 32 includes one or more light sources (e.g., light sources 38, 40, and 42) and emits light in a way corresponding to the settings of an operation assistant included in the device 10A. Setting items such as age, gender, occupation, and personality are set in the operation assistant. The operation assistant responds to the user or performs a task in accordance with the setting items. For example, when the occupation in the setting items indicates “physician”, blue light is emitted from the light sources 38 and 42 and yellow light is emitted from the light source 40. When the setting items are set in a different manner, the light-emitting unit 32 emits light in a way corresponding to the settings.

The light-emitting unit 34 includes one or more light sources (e.g., light sources 44, 46, and 48) and emits light in a way corresponding to a user account currently logged into the operation assistant included in the device 10A. For example, when a user B is currently logged into the operation assistant included in the device 10A, blue light is emitted from the light sources 44 and 48 and yellow light is emitted from the light source 46. When a different user is currently logged into the operation assistant, the light-emitting unit 34 emits light in a way corresponding to the login user.

The light-emitting units 32 and 34 may be disposed on the main body 24 in an indistinguishable manner. For example, all of the light sources included in the light-emitting units 32 and 34 may be used to represent the settings of the operation assistant or a user account. Alternatively, the settings of the operation assistant or a user account may be represented by using the light-emission pattern (such as the way or the duration of blinking) of each light source.

The sensor 36 detects a gesture of the user. The device 10A performs a process corresponding to the detected gesture. For example, the device 10A may perform a process alone or control the operation of another device 10 in accordance with the detected gesture.

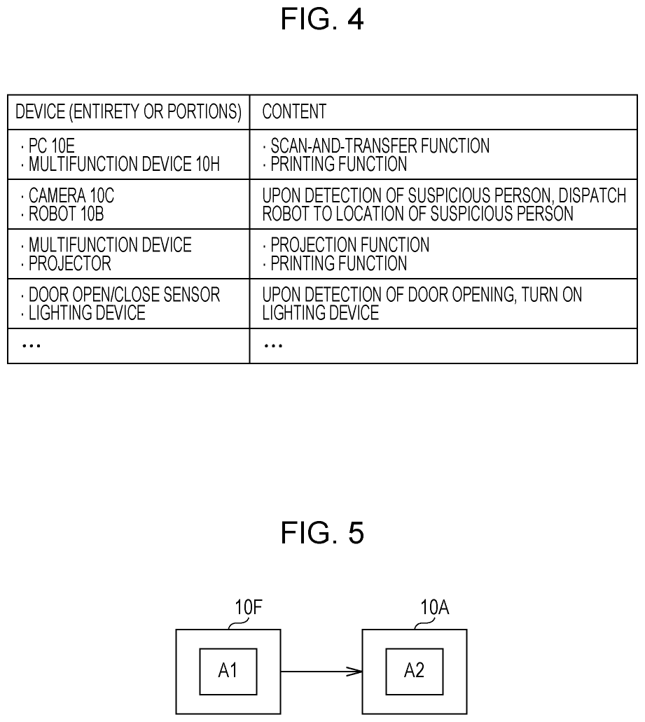

The following describes collaborative functions in detail with reference to FIG. 4. FIG. 4 illustrates an example of a function management table. The function management table is a table for managing collaborative functions set in the devices 10. The data of the function management table may be stored in the devices 10 in which the collaborative functions are set or in the devices 10 used to set the collaborative functions. Alternatively, the data of the function management table may be stored in a server for controlling the devices 10 or in a relay. For example, when a user provides an instruction to set a collaborative function by using the device 10F serving as a smartphone, the data of the function management table may be stored in the device 10F. When a collaborative function is set in a device 10 connected to the device 10A serving as a relay, the function management table may be stored in the device 10A.

In the function management table, as an example, information indicating a plurality of devices 10 used for a collaborative function and information indicating the content of the collaborative function set in the plurality of devices 10 are associated with each other. The following describes a specific example of the collaborative functions registered in the function management table.

Information indicating a combination of the device 10E serving as a PC and the device 10H serving as a multifunction device is associated with information indicating collaborative functions set in the devices 10E and 10H. The collaborative functions are a “scan-and-transfer function” and a “printing function”. The scan-and-transfer function is a function of “scanning (reading) an image to generate image data using a multifunction device (the device 10H) having a scanning function and transferring the image data from the multifunction device (the device 10H) to a PC (the device 10E)”. The printing function is a function of “sending data saved in a PC (the device 10E) to a multifunction device (the device 10H) and printing the data using the multifunction device”. When a user gives an instruction to execute the scan-and-transfer function, the devices 10E and 10H execute the scan-and-transfer function. Likewise, when a user gives an instruction to execute the printing function, the devices 10E and 10H execute the printing function.

Further, information indicating a combination of the device 10C serving as a camera and the device 10B serving as a robot is associated with information indicating a collaborative function set in the devices 10B and 10C. The collaborative function is a function of “upon detection of a suspicious person by a camera (the device 10C), dispatching a robot (the device 10B) to the location where the suspicious person is detected”. When the collaborative function is set to be active (in an on state), the devices 10B and 10C execute the collaborative function.

Further, information indicating a combination of a multifunction device and a projector is associated with information indicating collaborative functions set in the combination of the multifunction device and the projector. The collaborative functions are a “projection function” and a “printing function”. The projection function is a function of “scanning an image to generate image data using a multifunction device having a scanning function and projecting the image data using a projector”. The printing function is a function of “sending image data projected by a projector to a multifunction device and printing the image data using the multifunction device”. When a user gives an instruction to execute the projection function, the multifunction device and the projector execute the projection function. Likewise, when a user gives an instruction to execute the printing function, the multifunction device and the projector execute the printing function.

Further, information indicating a combination of a door open/close sensor and a lighting device is associated with information indicating a collaborative function set in the combination of the door open/close sensor and the lighting device. The collaborative function is a function of “upon detection of the opening of a door using a door open/close sensor, turning on a lighting device”. When the collaborative function is set to be active (in an on state), the door open/close sensor and the lighting device execute the collaborative function.

The collaborative functions illustrated in FIG. 4 are examples, and other collaborative functions may be set in the devices 10. In addition, collaborative functions using software may be set.

The following describes some examples according to the first exemplary embodiment in detail.

### EXAMPLE 1-1

A process according to Example 1-1 will be described with reference to FIG. 5. FIG. 5 illustrates an example of the devices 10. In Example 1-1, the device 10F serving as a smartphone corresponds to the requesting device, and the device 10A serving as a relay corresponds to the requested device. That is, the device 10F transmits information indicating a connection request to the device 10A. For example, the device 10F transmits information indicating a connection request to the device 10A when a standalone function included in the device 10A is executed, when the device 10F is used to set a standalone function in the device 10A, when the device 10F and the device 10A work in collaboration to execute a collaborative function, when the device 10F is used to set a collaborative function in the device 10A, when the device 10F is used to set a collaborative function in another device 10 through the device 10A, when the device 10A is used through the device 10F, or when a user gives an instruction to transmit a connection request by using the device 10F. It is to be understood that the device 10F may transmit information indicating a connection request to the device 10A when any other event occurs.

The device 10F includes an operation assistant A1. The device 10A includes an operation assistant A2. For example, the operation assistants A1 and A2 may be of an identical type or of different types. For example, the operation assistants A1 and A2 may have an identical type of artificial intelligence (AI) or may have different types of artificial intelligence (AI). Even if the operation assistants A1 and A2 are of an identical type (e.g., even if the operation assistants A1 and A2 have an identical type of AI), the operation assistants A1 and A2 may be handled as different operation assistants when the versions are different, when controllable functions or devices are different, when users available are different, or when the login user accounts are different. If the operation assistants A1 and A2 have different degrees of learning, the operation assistants A1 and A2 may be handled as different operation assistants.

In the example illustrated in FIG. 5, the device 10F corresponds to an example of a first device, and the device 10A corresponds to an example of a second device. Further, the operation assistant A1 corresponds to an example of a first operation assistant, and the operation assistant A2 corresponds to an example of a second operation assistant.

When information indicating a connection request is transmitted from the device 10F to the device 10A, the assistant control unit 22 sets the operation assistant A1 included in the requesting device 10F as a master operation assistant to cause the operation assistant A1 to operate as a master operation assistant. Further, the assistant control unit 22 sets the operation assistant A2 included in the requested device 10A as a slave operation assistant to cause the operation assistant A2 to operate as a slave operation assistant. That is, the assistant control unit 22 sets up a master-slave relationship between the operation assistant A1 and the operation assistant A2. The operation assistant A2 serving as the slave operation assistant operates in accordance with an instruction from the operation assistant A1 serving as the master operation assistant. For example, when a user gives an instruction intended for the device 10A to the operation assistant A1 by using the device 10F, the operation assistant A1 gives the instruction to the operation assistant A2 included in the device 10A. The operation assistant A2 operates in accordance with the instruction. For example, the operation assistant A2 controls the operation of the device 10A in accordance with the instruction from the operation assistant A1.

The master-slave relationship described above may be set up by the assistant control unit 22 of the requesting device 10F, by the assistant control unit 22 of the requested device 10A, or by the assistant control unit 22 included in an external device such as a server.

For example, when the device 10F transmits information indicating a connection request to the device 10A, the assistant control unit 22 of the device 10F sets the operation assistant A1 included in the device 10F as a master operation assistant. Further, the assistant control unit 22 of the device 10F transmits information indicating an instruction for a slave operation assistant (including information for identifying the operation assistant A1 as the master operation assistant) to the device 10A to set the operation assistant A2 included in the device 10A as a slave operation assistant that operates in accordance with an instruction from the operation assistant A1 included in the device 10F.

As another example, when the device 10F transmits information indicating a connection request to the device 10A, the assistant control unit 22 of the device 10F sets the operation assistant A1 included in the device 10F as a master operation assistant. Upon receipt of the information indicating a connection request (including information for identifying the operation assistant A1 as the master operation assistant) from the device 10F, the assistant control unit 22 of the device 10A sets the operation assistant A2 as a slave operation assistant that operates in accordance with an instruction from the operation assistant Al included in the device 10F.

As still another example, when the device 10F transmits information indicating a connection request to the device 10A, the device 10F transmits information indicating that the device 10F is the requesting device, information indicating that the device 10A is the requested device, and device address information indicating the respective addresses of the devices 10F and 10A to an external device such as a server. Upon receipt of the information described above, the assistant control unit 22 of the external device transmits information indicating a master operation assistant to the device 10F to set the operation assistant A1 as a master operation assistant and transmits information indicating a slave operation assistant to the device 10A to set the operation assistant A2 as a slave operation assistant.

In a period during which a master-slave relationship holds between the operation assistant A1 and the operation assistant A2, in some cases, an instruction may be provided to the operation assistant A2 without the intervention of the operation assistant A1. For example, an instruction may be provided directly to the device 10A or an instruction may be provided from a device 10 other than the device 10F to the device 10A without the intervention of the operation assistant A1. In these cases, the operation assistant A2 does not operate in accordance with the instruction provided to the operation assistant A2 without the intervention of the operation assistant A1, but operates in accordance with an instruction from the operation assistant A1. In this case, after the master-slave relationship is terminated in a way described below, the operation assistant A2 operates in accordance with the instruction provided to the operation assistant A2 without the intervention of the operation assistant A1 in the period during which the master-slave relationship holds. It is to be understood that, even in the period during which the master-slave relationship holds, the operation assistant A2 may operate in accordance with an instruction provided to the operation assistant A2 without the intervention of the operation assistant A1 so long as no instruction is provided from the operation assistant A1 to the operation assistant A2.

When the operation assistant A2 is performing a task at the time when information indicating a connection request is transmitted from the device 10F to the device 10A, the assistant control unit 22 sets the operation assistant A2 as a slave operation assistant after the task is completed. It is to be understood that a connection request takes priority. In this case, the assistant control unit 22 temporarily stops the task currently performed by the operation assistant A2 and sets the operation assistant A2 as a slave operation assistant. After the master-slave relationship is terminated, the operation assistant A2 resumes the task that has been stopped.

When the operation assistant A2 serving as the slave operation assistant is caused to finish a task corresponding to an instruction from the operation assistant A1 serving as the master operation assistant, the assistant control unit 22 terminates the master-slave relationship described above. For example, when the device 10A finishes execution of a standalone function corresponding to an instruction from the device 10F, the assistant control unit 22 terminates the master-slave relationship between the operation assistant A1 and the operation assistant A2. As another example, a collaborative function that uses the device 10F and the device 10A is set. When execution of the collaborative function is completed, the assistant control unit 22 terminates the master-slave relationship between the operation assistant A1 and the operation assistant A2. The termination of the master-slave relationship may be performed by the assistant control unit 22 of the requesting device 10F, by the assistant control unit 22 of the requested device 10A, or by the assistant control unit 22 included in the external device. After the master-slave relationship is terminated, the operation assistant A2 operates in accordance with an instruction provided to the operation assistant A2, regardless of whether the instruction is provided from the operation assistant A1.

According to Example 1-1, an operation assistant included in the requested device 10 operates in accordance with an instruction from an operation assistant included in the requesting device 10. Accordingly, since a master-slave relationship is established between the operation assistants, the devices 10 may be appropriately controlled when the devices 10 are connected to each other.

If permission is obtained from a user associated with a user account that is currently logged into the operation assistant A2 included in the device 10A, the assistant control unit 22 may set the operation assistant A2 as a slave operation assistant. For example, a message for inquiring of the user about whether to permit setting the operation assistant A2 as a slave operation assistant is displayed on a display unit of the device 10A, which has received information indicating a connection request. If the user of the device 10A grants permission, the assistant control unit 22 sets the operation assistant A2 as a slave operation assistant. If the user of the device 10A does not grant permission, the assistant control unit 22 does not set the operation assistant A2 as a slave operation assistant. In this case, the operation assistant A2 operates in accordance with an instruction provided to the operation assistant A2, regardless of whether the instruction is provided from the operation assistant A1. Accordingly, if the user of the requested device 10 grants permission, the operation assistant in the requested device 10 is set as a slave operation assistant. This may prevent the operation assistant in the requested device 10 from being set as a slave operation assistant without permission of the user.

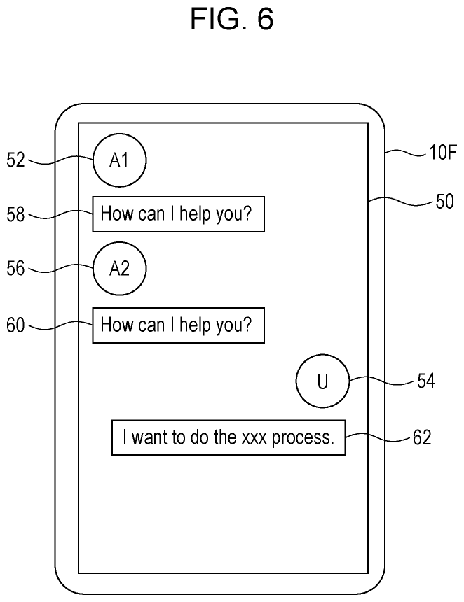

The following describes a screen in a period during which a master-slave relationship holds with reference to FIG. 6. FIG. 6 illustrates an example of the screen. A screen 50 is a screen displayed on the requesting device 10F.

The control unit 20 of the device 10F causes a display unit of the UI unit 14 to display the screen 50, and various kinds of information are displayed on the screen 50. The screen 50 is a user interface (conversational user interface) for allowing a user to interact with an operation assistant. That is, the screen 50 is a user interface for exchanging messages between an operation assistant and a user. The screen 50 displays information (such as a character string or an image) input to the device 10F by the user, and information (such as a character string or an image) indicating the content of an utterance produced by the operation assistant. The interaction between the user and the operation assistant is a so-called chat-type interaction (i.e., a type in which an interaction moves forward through a real-time transmission of messages between the user and the operation assistant). For example, the device 10F has installed therein a program for interacting with an operation assistant (e.g., a chat program). The chat program is executed to display the screen 50.

An operation assistant display area displays an image (such as an icon) associated with the operation assistant A1 included in the device 10F. A user display area displays an image 54 (such as an icon or a picture) associated with the user. When the operation assistant A2 included in the device 10A is operating as a slave operation assistant, the operation assistant display area displays an image 56 (such as an icon) associated with the operation assistant A2. Instead of or in addition to images, character strings for identifying the user and each operation assistant may be displayed.

On the screen 50, an interaction is carried out between the user and the operation assistants A1 and A2. During the interaction, the content of an utterance 58 produced by the operation assistant A1 is displayed in association with the image 52, the content of an utterance 60 produced by the operation assistant A2 is displayed in association with the image 56, and the content of an utterance 62 produced by the user is displayed in association with the image 54. An instruction intended for the operation assistant A2 is provided through the operation assistant A1. The image 56 associated with the operation assistant A2 serving as the slave operation assistant may not necessarily be displayed on the screen 50.

An additional user may participate in the interaction between the user and the operation assistants A1 and A2. In this case, an image associated with the additional user is displayed on the screen 50. The content of an utterance produced by the additional user is displayed on the screen 50 in association with the image.

The user may provide a message to an operation assistant by using a speech or gesture. In this case, the screen 50 may not necessarily be displayed. Even when a speech or gesture is used, the screen 50 may be displayed and the content of the speech or gesture may be displayed on the screen 50 as a character string.

For example, when the user provides an instruction to the operation assistant A1 on the screen 50 to execute a collaborative function that uses the devices 10F and 10A, the operation assistant A1 controls the execution of the collaborative function. For example, the operation assistant A1 controls the device 10F and provides an instruction to the operation assistant A2 to execute the collaborative function. In this way, the collaborative function is executed.

### EXAMPLE 1-2

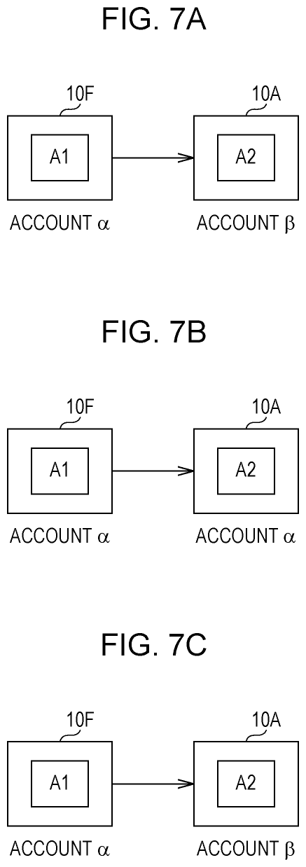

A process according to Example 1-2 will be described with reference to FIGS. 7A to 7C. FIGS. 7A to 7C illustrate an example of the devices 10. In Example 1-2, as in Example 1-1, the device 10F corresponds to the requesting device, and the device 10A corresponds to the requested device.

As illustrated in FIG. 7A, the device 10F includes the operation assistant A1. The device 10A includes the operation assistant A2. A user associated with an account α is currently logged into the operation assistant A1 included in the device 10F. A user associated with an account β is currently logged into the operation assistant A2 included in the device 10A.

The device 10F corresponds to an example of a first device, and the device 10A corresponds to an example of a second device. Further, the operation assistant A1 corresponds to an example of a first operation assistant, and the operation assistant A2 corresponds to an example of a second operation assistant. Further, the account α corresponds to an example of a first account, and the account β corresponds to an example of a second account.

When information indicating a connection request is transmitted from the device 10F to the device 10A, as illustrated in FIG. 7B, the assistant control unit 22 causes the account β to log out from the operation assistant A2 and causes the account α currently logged into the operation assistant A1 in the requesting device 10F to log into the operation assistant A2. This allows the assistant control unit 22 to set the operation assistant A2 as a slave operation assistant. Further, the assistant control unit 22 sets the operation assistant A1 into which the account α is currently logged as a master operation assistant. In this way, the assistant control unit 22 sets up a master-slave relationship between the operation assistant A1 and the operation assistant A2. The operation assistant A2 serving as the slave operation assistant operates in accordance with an instruction from the operation assistant A1 into which the account α is currently logged. For example, when the user associated with the account α provides an instruction intended for the device 10A to the operation assistant A1 by using the device 10F, the operation assistant A1 provides the instruction to the operation assistant A2 included in the device 10A. The operation assistant A2 operates in accordance with the instruction. Accordingly, the operation assistant A2 operates in accordance with an instruction from the user associated with the account α.

As in Example 1-1, the master-slave relationship described above may be set up by the assistant control unit 22 of the requesting device 10F, by the assistant control unit 22 of the requested device 10A, or by the assistant control unit 22 included in an external device such as a server.

For example, when the device 10F transmits information indicating a connection request to the device 10A, the assistant control unit 22 of the device 10F sets the operation assistant A1 included in the device 10F as a master operation assistant. Further, the assistant control unit 22 of the device 10F transmits account control information to the device 10A. The account control information includes information for providing an instruction to cause the account β currently logged into the operation assistant A2 in the requested device 10A to log out from the operation assistant A2, and information for providing an instruction to cause the account α currently logged into the operation assistant A1 included in the requesting device 10F to log into the operation assistant A2. The assistant control unit 22 of the device 10F transmits the account control information to the device 10A to cause the account β to log out from the operation assistant A2 and to cause the account α to log into the operation assistant A2. This allows the operation assistant A2 to operate not in accordance with an instruction from the user associated with the account β (the device 10A) but in accordance with an instruction from the user associated with the account α (the device 10F).

As another example, when the device 10F transmits information indicating a connection request to the device 10A, the assistant control unit 22 of the device 10F sets the operation assistant A1 included in the device 10F as a master operation assistant. Further, the assistant control unit 22 of the device 10F transmits information indicating the account α currently logged into the operation assistant A1 included in the device 10F to the device 10A. Upon receipt of the information indicating a connection request and the information indicating the account α from the device 10F, the assistant control unit 22 of the device 10A causes the account β to log out from the operation assistant A2 and causes the account α to log into the operation assistant A2. This allows the operation assistant A2 to operate not in accordance with an instruction from the user associated with the account β (the device 10A) but in accordance with an instruction from the user associated with the account α (the device 10F).

As still another example, when the device 10F transmits information indicating a connection request to the device 10A, the device 10F transmits information indicating that the device 10F is the requesting device, information indicating that the device 10A is the requested device, and device address information indicating the respective addresses of the devices 10F and 10A to an external device such as a server. Upon receipt of the information described above, the assistant control unit 22 of the external device transmits the information indicating the master operation assistant to the device 10F to set the operation assistant A1 as a master operation assistant. Further, the assistant control unit 22 of the external device acquires information indicating the account α from the device 10F and transmits account control information including the acquired information to the device 10A to cause the account β to log out from the operation assistant A2 and to cause the account a to log into the operation assistant A2.

As in Example 1-1, in a period during which a master-slave relationship holds between the operation assistant A1 and the operation assistant A2, in some cases, an instruction may be provided to the operation assistant A2 without the intervention of the operation assistant A1. In this case, the operation assistant A2 does not operate in accordance with the instruction provided to the operation assistant A2 without the intervention of the operation assistant A1 (an instruction from an account other than the account α), but operates in accordance with an instruction from the operation assistant A1 (the account α). In this case, after the master-slave relationship is terminated, the operation assistant A2 operates in accordance with the instruction provided to the operation assistant A2 without the intervention of the operation assistant A1 in the period during which the master-slave relationship holds. It is to be understood that, even in the period during which the master-slave relationship holds, the operation assistant A2 may operate in accordance with an instruction provided to the operation assistant A2 without the intervention of the operation assistant A1 so long as no instruction is provided from the operation assistant A1 to the operation assistant A2.

When the account α logs out from the operation assistant A2, the assistant control unit 22 terminates the master-slave relationship described above. For example, when the device 10A finishes execution of a standalone function corresponding to an instruction from the device 10F and the account α logs out from the operation assistant A2, the assistant control unit 22 terminates the master-slave relationship between the operation assistant A1 and the operation assistant A2. As another example, a collaborative function that uses the device 10F and the device 10A is set. When execution of the collaborative function is completed and the account α logs out from the operation assistant A2, the assistant control unit 22 terminates the master-slave relationship between the operation assistant A1 and the operation assistant A2. More specifically, as illustrated in FIG. 7C, the assistant control unit 22 causes the account a to log out from the operation assistant A2 and causes the account β to log into the operation assistant A2 again. This allows the operation assistant A2 to operate not in accordance with an instruction from the user associated with the account α (an instruction from the operation assistant A1) but in accordance with an instruction from the user associated with the account β. Alternatively, when the account α logs out from the operation assistant A2 in accordance with an instruction given from the user, the assistant control unit 22 may cause the account β to log into the operation assistant A2 to terminate the master-slave relationship. As in Example 1-1, the master-slave relationship described above is terminated under control of the assistant control unit 22 included in the device 10F, the device 10A, or the external device.

According to Example 1-2, controlling login and logout of an account to and from an operation assistant included in the requested device 10 enables an operation assistant included in the requested device 10 to operate in accordance with an instruction from the operation assistant included in the requesting device 10. Accordingly, since a master-slave relationship is established between the operation assistants, the devices 10 may be appropriately controlled when the devices 10 are connected to each other.

Information indicating an instruction provided from the operation assistant A1 serving as the master operation assistant to the operation assistant A2 serving as the slave operation assistant is not stored in the device 10A. For example, when the account α logs out from the operation assistant A2, the assistant control unit 22 of the requested device 10A deletes the information indicating the instruction from the device 10A. The information indicating the instruction may be deleted from the device 10A by the assistant control unit 22 of the requesting device 10F or by the assistant control unit 22 included in the external device. This may prevent the information indicating the instruction from leaking from the device 10A and ensure security of the information indicating the instruction. History information indicating that the device 10F has been connected to the device 10A may be stored in the device 10A. The deletion of the information indicating the instruction or the storage of the history information may be performed in Example 1-1 or may be performed in the following examples.

As in Example 1-1, the screen 50 for interacting with an operation assistant may be displayed on a display unit of the device 10F.

In addition, if permission is obtained from the user associated with the account β currently logged into the operation assistant A2 included in the requested device 10A, the assistant control unit 22 may cause the account β to log off from the operation assistant A2 and cause the account α to log into the operation assistant A2. If the permission is not obtained, the assistant control unit 22 keeps login of the account β to the operation assistant A2 and does not allow the account α to log into the operation assistant A2. This may prevent the account β from logging off from the operation assistant A2 and the operation assistant A2 from being set as a slave operation assistant without permission of the user associated with the account β.

EXAMPLE 1-3

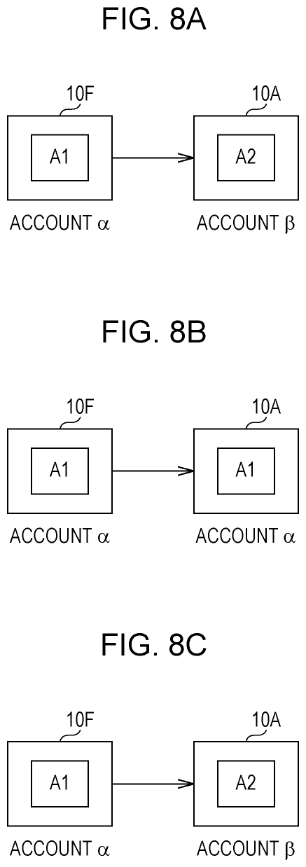

A process according to Example 1-3 will be described with reference to FIGS. 8A to 8C. FIGS. 8A to 8C illustrate an example of the devices 10. In Example 1-3, as in Example 1-1, the device 10F corresponds to the requesting device, and the device 10A corresponds to the requested device.

As illustrated in FIG. 8A, the device 10F includes the operation assistant A1. The device 10A includes the operation assistant A2. A user associated with an account α is currently logged into the operation assistant A1 included in the device 10F. A user associated with an account β is currently logged into the operation assistant A2 included in the device 10A.

The device 10F corresponds to an example of a first device, and the device 10A corresponds to an example of a second device. Further, the operation assistant A1 corresponds to an example of a first operation assistant, and the operation assistant A2 corresponds to an example of a second operation assistant. Further, the account α corresponds to an example of a first account, and the account β corresponds to an example of a second account.

When information indicating a connection request is transmitted from the device 10F to the device 10A, as illustrated in FIG. 8B, the assistant control unit 22 switches the operation assistant enabled on the device 10A from the operation assistant A2 to the operation assistant A1 included in the device 10F. This allows the assistant control unit 22 to set an operation assistant enabled on the device 10A as a slave operation assistant that operates in accordance with an instruction from the device 10F.

For example, the assistant control unit 22 completes activation of the operation assistant A2 included in the device 10A (or sets the operation assistant A2 to an off state), activates the operation assistant A1 on the device 10A (or sets the operation assistant A1 to an on state), and then sets the operation assistant A1 as a slave operation assistant. For example, an operation assistant program for the operation assistant A2 is currently executed on the device 10A. The assistant control unit 22 finishes the operation assistant program to complete activation of the operation assistant A2. Further, the assistant control unit 22 executes an operation assistant program for the operation assistant A1 on the device 10A to activate the operation assistant A1. Further, the assistant control unit 22 sets the operation assistant A1 included in the device 10F as a master operation assistant. The operation assistant A1 serving as a slave operation assistant operates in accordance with an instruction from the operation assistant A1 serving as the master operation assistant.

When the device 10A has installed therein the operation assistant program for the operation assistant A1, the assistant control unit 22 executes the installed operation assistant program. When the device 10A does not have installed therein the operation assistant program, the assistant control unit 22 downloads the operation assistant program from an external device such as a server, installs the operation assistant program into the device 10A, and executes the installed operation assistant program.

Further, the assistant control unit 22 causes the account α, which is currently logged into the operation assistant A1 serving as the master operation assistant in the device 10F, to log into the operation assistant A1 operating as the slave operation assistant in the device 10A. This allows the operation assistant A1 serving as a slave operation assistant to operate in accordance with an instruction from the user associated with the account α. When activation of the operation assistant A2 is finished, the account β is caused to automatically log out from the operation assistant A2.

As in Example 1-1, the master-slave relationship described above may be set up by the assistant control unit 22 of the requesting device 10F, by the assistant control unit 22 of the requested device 10A, or by the assistant control unit 22 included in an external device such as a server.

For example, when the device 10F transmits information indicating a connection request to the device 10A, the assistant control unit 22 of the device 10F sets the operation assistant A1 included in the device 10F as a master operation assistant. Further, the assistant control unit 22 of the device 10F transmits assistant control information to the device 10A. The assistant control information is information indicating an instruction to switch between operation assistants. Specifically, the assistant control information is information for providing an instruction to switch the operation assistant enabled on the device 10A to the operation assistant A1 included in the device 10F. The assistant control unit 22 of the device 10F transmits the assistant control information to the device 10A to switch the operation assistant enabled on the device 10A from the operation assistant A2 to the operation assistant A1.

As another example, when the device 10F transmits information indicating a connection request to the device 10A, the assistant control unit 22 of the device 10F sets the operation assistant A1 included in the device 10F as a master operation assistant. Further, the assistant control unit 22 of the device 10F transmits information indicating the operation assistant A1 included in the device 10F to the device 10A. Upon receipt of the information indicating a connection request and the information indicating the operation assistant A1 from the device 10F, the assistant control unit 22 of the device 10A switches the operation assistant enabled on the device 10A from the operation assistant A2 to the operation assistant A1.

As still another example, when the device 10F transmits information indicating a connection request to the device 10A, the device 10F transmits information indicating that the device 10F is the requesting device, information indicating that the device 10A is the requested device, and device address information indicating the respective addresses of the devices 10F and 10A to an external device such as a server. Upon receipt of the information described above, the assistant control unit 22 of the external device transmits the information indicating the master operation assistant to the device 10F to set the operation assistant A1 included in the device 10F as a master operation assistant. Further, the assistant control unit 22 of the external device acquires information indicating the operation assistant A1 from the device 10F and transmits the acquired information to the device 10A to switch the operation assistant enabled on the device 10A from the operation assistant A2 to the operation assistant A1.

As in Example 1-1, in a period during which the master-slave relationship described above holds, in some cases, an instruction may be provided to the operation assistant A1 serving as the slave operation assistant without the intervention of the operation assistant A1 serving as the master operation assistant. In this case, the operation assistant A1 serving as the slave operation assistant does not operate in accordance with the instruction provided without the intervention of the operation assistant A1 serving as the master operation assistant, but operates in accordance with an instruction from the operation assistant A1 serving as the master operation assistant. In this case, after the master-slave relationship is terminated, the operation assistant A2 operates in accordance with the instruction provided without the intervention of the master operation assistant in the period during which the master-slave relationship holds. It is to be understood that, even in the period during which the master-slave relationship holds, the slave operation assistant may operate in accordance with an instruction provided to the slave operation assistant without the intervention of the master operation assistant so long as no instruction is provided from the master operation assistant to the slave operation assistant.

When the operation assistant A1 serving as the slave operation assistant is caused to finish a task corresponding to an instruction from the operation assistant A1 serving as the master operation assistant, the assistant control unit 22 terminates the master-slave relationship described above. For example, when the device 10A finishes execution of a standalone function corresponding to an instruction from the device 10F, the assistant control unit 22 terminates the master-slave relationship between the operation assistant A1 and the operation assistant A2. As another example, a collaborative function that uses the device 10F and the device 10A is set. When execution of the collaborative function is completed, the assistant control unit 22 terminates the master-slave relationship. More specifically, as illustrated in FIG. 8C, after the master-slave relationship is terminated, the assistant control unit 22 switches the operation assistant enabled on the device 10A from the operation assistant A1 back to the operation assistant A2 again. For example, the assistant control unit 22 finishes the execution of the operation assistant program for the operation assistant A1 on the device 10A and executes the operation assistant program for the operation assistant A2. Further, the assistant control unit 22 causes the account β to log into the operation assistant A2 again. This disables the operation assistant A1 running on the device 10A and enables the operation assistant A2 on the device 10A. The operation assistant A2 operates in accordance with an instruction provided to the operation assistant A2, regardless of whether the instruction is provided from the operation assistant A1. As in Example 1-1, the master-slave relationship described above is terminated by the assistant control unit 22 included in the device 10F, the device 10A, or the external device.

According to Example 1-3, the operation assistant enabled on the requested device 10 is switched to an operation assistant enabled on the requesting device 10, thereby allowing the operation assistant included in the requested device 10 to operate in accordance with an instruction from the operation assistant included in the requesting device 10. Accordingly, since a master-slave relationship is established between the operation assistants, the devices 10 may be appropriately controlled when the devices 10 are connected to each other.

As in Example 1-1, the screen 50 for interacting with an operation assistant may be displayed on a display unit of the device 10F.

In addition, if permission is obtained from the user associated with the account β currently logged into the operation assistant A2 included in the requested device 10A, the assistant control unit 22 may switch the operation assistant enabled on the requested device 10A from the operation assistant A2 to the operation assistant A1. If the permission is not obtained, the assistant control unit 22 does not switch the operation assistant enabled on the device 10A. This may prevent the operation assistant enabled on the device 10A from being switched from the operation assistant A2 to another operation assistant without permission of the user associated with the account β.

EXAMPLE 1-4

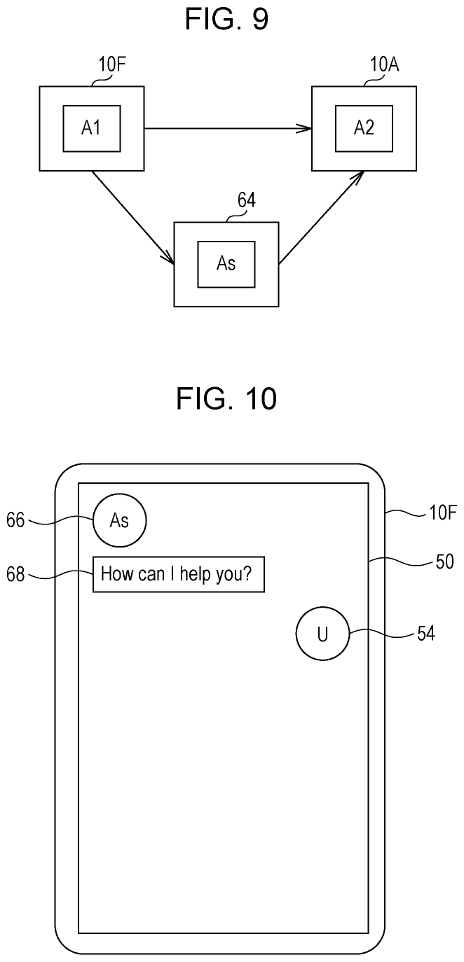

A process according to Example 1-4 will be described with reference to FIG. 9. FIG. 9 illustrates an example of the devices 10. In Example 1-4, as in Example 1-1, the device 10F corresponds to the requesting device, and the device 10A corresponds to the requested device.

The device 10F includes the operation assistant A1. The device 10A includes the operation assistant A2.

The device 10F corresponds to an example of a first device, and the device 10A corresponds to an example of a second device. Further, the operation assistant A1 corresponds to an example of a first operation assistant, and the operation assistant A2 corresponds to an example of a second operation assistant.

When information indicating a connection request is transmitted from the device 10F to the device 10A, the assistant control unit 22 controls the operation assistant A2 included in the device 10A by using a standard operation assistant As serving as a third operation assistant to cause the operation assistant A2 to operate as a slave operation assistant. Further, the assistant control unit 22 sets the operation assistant A1 included in the device 10F as a master operation assistant. The standard operation assistant As has a function of interacting with, for example, a plurality of types of operation assistants and controlling the plurality of types of operation assistants. For example, the standard operation assistant As exchanges messages with the operation assistants A1 and A2 and controls the operation assistants A1 and A2. The standard operation assistant As may individually control a plurality of operation assistants or transversely control a plurality of operation assistants by causing the plurality of operation assistants to work in collaboration.

The standard operation assistant As may have a function that a plurality of types of operation assistants have in common. In this case, the standard operation assistant As may or may not have a function that a plurality of types of operation assistants do not have in common. For example, the standard operation assistant As has a function that the operation assistants A1 and A2 have in common, but does not have a function that the operation assistants A1 and A2 do not have in common.

The standard operation assistant As, which is capable of interacting with a plurality of types of operation assistants, may be an operation assistant having a function with lower performance than any other assistant.

For example, the standard operation assistant As receives an instruction from the operation assistant A1 serving as the master operation assistant and controls the operation assistant A2 serving as the slave operation assistant in accordance with the instruction. This allows the operation assistant A2 to operate in accordance with an instruction from the operation assistant A1 through the standard operation assistant As.

The standard operation assistant As may be included in the requesting device 10F, the requested device 10A, or an external device such as a server. In the example illustrated in FIG. 9, the standard operation assistant As is included in an external device 64. That is, an operation assistant program for the standard operation assistant As is stored in the external device 64. The operation assistant program is executed to operate the standard operation assistant As on the external device 64.

As in Example 1-1, the master-slave relationship described above may be set up by the assistant control unit 22 of the requesting device 10F, by the assistant control unit 22 of the requested device 10A, or by the assistant control unit 22 included in an external device such as a server (e.g., the external device 64).

For example, when the device 10F transmits information indicating a connection request to the device 10A, the assistant control unit 22 of the device 10F sets the operation assistant A1 included in the device 10F as a master operation assistant. Further, the assistant control unit 22 of the device 10F transmits control request information to the external device 64. The control request information is information for requesting the external device 64 to perform control using the standard operation assistant As, and is information including device address information indicating the address of the requested device 10A. The assistant control unit 22 of the device 10F transmits the control request information to the external device 64 to activate the standard operation assistant As included in the external device 64, and causes the standard operation assistant As to control the operation assistant A2 included in the requested device 10A. The operation assistant A1 included in the device 10F transmits information indicating an instruction to the standard operation assistant As. The standard operation assistant As controls the operation assistant A2 in accordance with the instruction. That is, the operation assistant A2 operates in accordance with an instruction provided from the operation assistant A1 through the standard operation assistant As. Accordingly, the operation assistant A2 operates as a slave operation assistant.

As another example, when the device 10F transmits information indicating a connection request to the device 10A, the assistant control unit 22 of the device 10F sets the operation assistant A1 included in the device 10F as a master operation assistant. Upon receipt of the information indicating a connection request from the device 10F, the assistant control unit 22 of the device 10A transmits the control request information described above to the external device 64 to activate the standard operation assistant As included in the external device 64, and causes the standard operation assistant As to control the operation assistant A2 included in the device 10A. The operation assistant A2 operates in accordance with an instruction provided from the operation assistant A1 through the standard operation assistant As. Accordingly, the operation assistant A2 operates as a slave operation assistant.

As still another example, when the device 10F transmits information indicating a connection request to the device 10A, the device 10F transmits information indicating that the device 10F is the requesting device, information indicating that the device 10A is the requested device, and device address information indicating the respective addresses of the devices 10F and 10A to the external device 64. Upon receipt of the information described above, the assistant control unit 22 of the external device 64 transmits the information indicating the master operation assistant to the device 10F to set the operation assistant A1 included in the device 10F as a master operation assistant. Further, the assistant control unit 22 of the external device 64 activates the standard operation assistant As included in the external device 64, and causes the standard operation assistant As to control the operation assistant A2 included in the device 10A. The operation assistant A2 operates in accordance with an instruction provided from the operation assistant A1 through the standard operation assistant As. Accordingly, the operation assistant A2 operates as a slave operation assistant.

As in Example 1-1, in a period during which the master-slave relationship described above holds, in some cases, an instruction may be provided to the operation assistant A2 serving as the slave operation assistant without the intervention of the standard operation assistant As. In this case, the operation assistant A2 does not operate in accordance with the instruction provided without the intervention of the standard operation assistant As, but operates in accordance with an instruction provided from the operation assistant A1 through the standard operation assistant As. In this case, after the master-slave relationship is terminated, the operation assistant A2 operates in accordance with the instruction provided without the intervention of the standard operation assistant As in the period during which the master-slave relationship holds. It is to be understood that, even in the period during which the master-slave relationship holds, the operation assistant A2 may operate in accordance with an instruction provided to the operation assistant A2 without the intervention of the standard operation assistant As so long as no instruction is provided from the standard operation assistant As to the operation assistant A2.

When the operation assistant A2 serving as the slave operation assistant is caused to finish a task corresponding to an instruction from the operation assistant A1 serving as the master operation assistant, the assistant control unit 22 terminates the master-slave relationship described above. For example, when the device 10A finishes execution of a standalone function corresponding to an instruction from the device 10F, the assistant control unit 22 terminates the master-slave relationship between the operation assistant A1 and the operation assistant A2. As another example, a collaborative function that uses the device 10F and the device 10A is set. When execution of the collaborative function is completed, the assistant control unit 22 terminates the master-slave relationship. This allows the operation assistant A2 to operate in accordance with an instruction provided to the operation assistant A2, regardless of whether the instruction is provided from the operation assistant A1 through the standard operation assistant As. As in Example 1-1, the master-slave relationship described above is terminated by the assistant control unit 22 included in the device 10F, the device 10A, or the external device 64.

According to Example 1-4, an operation assistant included in the requested device 10 is controlled through a standard operation assistant. Accordingly, when the devices 10 are connected to each other, the device 10 may be appropriately controlled.

The assistant control unit 22 may control an operation assistant included in the requesting device 10 by using a standard operation assistant. In the example illustrated in FIG. 9, the operation assistant A1 included in the requesting device 10F operates in accordance with an instruction from the standard operation assistant As included in the external device 64. For example, when a user provides an instruction to an operation assistant by using the device 10F, information indicating the instruction is transmitted from the device 10F to the external device 64. Upon receipt of the information indicating the instruction, the standard operation assistant As controls the operation assistants A1 and A2 in accordance with the instruction. When execution of a collaborative function that uses the device 10F and the device 10A is completed, the assistant control unit 22 terminates the master-slave relationship between the operation assistant A1 and the standard operation assistant As. This allows the operation assistant A1 to operate in accordance with an instruction provided to the operation assistant A1, regardless of whether the instruction is given through the standard operation assistant As.

In addition, as in Example 1-3, the assistant control unit 22 may switch the operation assistant enabled on the requested device 10A from the operation assistant A2 to the standard operation assistant As. When the device 10A has installed therein an operation assistant program for the standard operation assistant As, the assistant control unit 22 executes the installed operation assistant program on the device 10A to activate the standard operation assistant As on the device 10A. Further, the assistant control unit 22 finishes execution of an operation assistant program for the operation assistant A2 on the device 10A. When the device 10A does not have installed therein the operation assistant program, the assistant control unit 22 downloads the operation assistant program into the device 10A and executes the downloaded operation assistant program. The standard operation assistant As included in the device 10A operates in accordance with, for example, an instruction provided from the operation assistant A1 through the standard operation assistant As included in the external device 64. The standard operation assistant As included in the device 10A may operate in accordance with an instruction provided from the operation assistant A1 without the intervention of the standard operation assistant As included in the external device 64. When execution of the collaborative function is completed, the assistant control unit 22 switches the operation assistant enabled on the device 10A from the standard operation assistant As back to the operation assistant A2 again.

The assistant control unit 22 may switch the operation assistant enabled on the requesting device 10F from the operation assistant A1 to the standard operation assistant As. The standard operation assistant As included in the device 10F provides an instruction to the operation assistant enabled on the device 10A (the operation assistant A2 or the standard operation assistant As) through the standard operation assistant As included in the external device 64 or without the intervention of the standard operation assistant As included in the external device 64. When execution of the collaborative function is completed, the assistant control unit 22 switches the operation assistant enabled on the device 10F from the standard operation assistant As back to the operation assistant A1 again.

The following describes a screen displayed in the period during which the master-slave relationship holds with reference to FIG. 10. FIG. 10 illustrates an example of the screen. A screen 50 is a screen displayed on the requesting device 10F.

The control unit 20 of the device 10F causes a display unit of the UI unit 14 to display the screen 50. The screen 50 is a user interface for exchanging messages between a user and the standard operation assistant As. For example, when the operation assistant enabled on the device 10F is switched from the operation assistant A1 to the standard operation assistant As, messages are exchanged between the user and the standard operation assistant As on the screen 50. The screen 50 has an operation assistant display area that displays an image 66 associated with the standard operation assistant As, and the content of an utterance 68 produced by the standard operation assistant As is displayed in association with the image 66. The screen 50 also has a user display area that displays an image 54 associated with the user.

On the screen 50, an interaction is carried out between the user and the standard operation assistant As. For example, when the user provides an instruction to the standard operation assistant As on the screen 50 to execute a collaborative function that uses the devices 10F and 10A, the standard operation assistant As controls the execution of execute the collaborative function. For example, the standard operation assistant As controls the devices 10F and 10A to cause the devices 10F and 10A to execute the collaborative function.

Even if the operation assistant enabled on the device 10F is not switched from the operation assistant A1 to the standard operation assistant As, the image 66 associated with the standard operation assistant As may be displayed on the screen 50. Even when the image 66 is displayed on the screen 50, the interaction partner that interacts with the user may be the operation assistant A1. It is to be understood that an image associated with the operation assistant A1, which actually interacts with the user, may be displayed on the screen 50 and the image 66 may not be displayed on the screen 50.

In addition, if permission is obtained from the user associated with the account β currently logged into the operation assistant A2 included in the requested device 10A, the assistant control unit 22 may set the operation assistant A2 as a slave operation assistant. If the permission is not obtained, the assistant control unit 22 does not set the operation assistant A2 as a slave operation assistant. This may prevent the operation assistant A2 included in the requested device 10A from being set as a slave operation assistant without permission of the user associated with the account β currently logged into the operation assistant A2 included in the requested device 10A.

The control unit 20 may display an image associated with a direct conversational partner (an operation assistant) of the user or an image associated with a different operation assistant other than the direct conversational partner on the screen 50. For example, when the standard operation assistant As is the direct conversational partner, as illustrated in FIG. 10, the control unit 20 may display the image 66 associated with the standard operation assistant As on the screen 50 or may display an image associated with the operation assistant A1 included in the device 10F on the screen 50. When the standard operation assistant As is the direct conversational partner, an image associated with the operation assistant A1 may be displayed although the user actually exchanges messages with the standard operation assistant As. In this case, the user is given the impression that the messages are being exchanged between the operation assistant A1 and the user. A screen for exchanging messages between the user and an operation assistant may be displayed on a display unit of the requested device 10. In this case, an image associated with the operation assistant included in the requested device 10 may be displayed as an image of the conversational partner of the user, or an image associated with the standard operation assistant As may be displayed as an image of the conversational partner.

Note that information indicating a plurality of operation instructions may be transmitted from the requesting device 10F to the external device 64 and may be stored in the external device 64. That is, a plurality of operation instructions may be provided to the standard operation assistant As included in the external device 64. In this case, the standard operation assistant As transmits each operation instruction to the operation target device 10.

### EXAMPLE 1-5

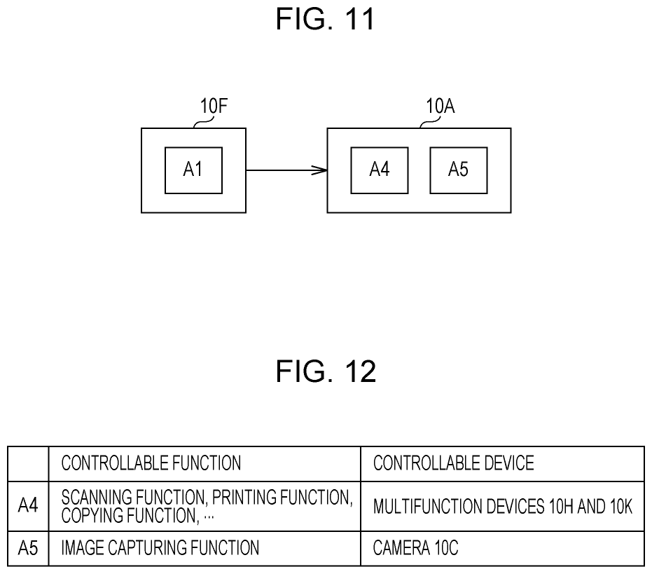

A process according to Example 1-5 will be described with reference to FIG. 11. FIG. 11 illustrates an example of the devices 10. In Example 1-5, as in Example 1-1, the device 10F corresponds to the requesting device, and the device 10A corresponds to the requested device.

In Example 1-5, the device 10 includes a plurality of operation assistants. An operation assistant to be enabled may be selected from among the plurality of operation assistants on the basis of a relationship with the other devices 10. An operation assistant to be enabled may be selected from among the plurality of operation assistants on the basis of a target function to be executed (a standalone function or a collaborative function).

A plurality of operation assistants included in the same device 10 are operation assistants of different types, for example. For example, the plurality of operation assistants are operation assistants having different types of artificial intelligence (AI). As another example, even if the plurality of operation assistants are operation assistants of an identical type (e.g., even if the plurality of operation assistants have an identical type of AI), the plurality of operation assistants may be handled as different operation assistants when the versions are different, when controllable functions or devices are different, when users available are different, or when the login user accounts are different.

The following describes Example 1-5 in detail. As illustrated in FIG. 11, the device 10F includes the operation assistant A1. The device 10A includes operation assistants A4 and A5. Accordingly, the device 10A includes a plurality of operation assistants.

For example, for each operation assistant, a function or functions controllable by the operation assistant, a device or devices controllable by the operation assistant, the number of devices controllable by the operation assistant, and so forth are determined in advance. For example, as illustrated in FIG. 12, the operation assistant A4 is capable of controlling image forming functions such as the scanning function, the printing function, and the copying function and is capable of controlling the devices 10H and 10K serving as multifunction devices. The operation assistant A5 is capable of controlling the image capturing function and is capable of controlling the device 10C serving as a camera.

When information indicating a connection request is transmitted from the device 10F to the device 10A, the assistant control unit 22 selects an operation assistant capable of controlling the target function to be executed from among the operation assistants A4 and A5 included in the device 10A as a slave operation assistant. For example, when a user provides an instruction to execute the image forming functions as a standalone function or to execute a collaborative function using the image forming functions, the assistant control unit 22 selects the operation assistant A4 capable of executing the image forming functions as a slave operation assistant. Further, the assistant control unit 22 sets the operation assistant A1 included in the device 10F as a master operation assistant. The operation assistant A1 exchanges information with the operation assistant A4 serving as the slave operation assistant to control execution of the instructed function. For example, the assistant control unit 22 executes an operation assistant program for the operation assistant A4 to activate the operation assistant A4, sets the operation assistant A4 as a slave operation assistant, and finishes the execution of the operation assistant program for the operation assistant A5 to disable the operation assistant A5.

When both the operation assistants A4 and A5 are capable of controlling the target function to be executed, the assistant control unit 22 may randomly select any one of the operation assistants A4 and A5 as a slave operation assistant, may select an operation assistant having a larger number of controllable devices or functions as a slave operation assistant, may select an operation assistant having less load as a slave operation assistant, or may select an operation assistant that is not currently performing a process as a slave operation assistant.

When information indicating a connection request is transmitted from the device 10F to the device 10A, the assistant control unit 22 may select a slave operation assistant from among the operation assistants A4 and A5 included in the device 10A on the basis of the number of controllable devices. For example, the assistant control unit 22 selects the operation assistant having the largest number of controllable devices as a slave operation assistant. For example, the operation assistant A4 is capable of controlling two devices 10, and the operation assistant A5 is capable of controlling one device 10. In this case, the assistant control unit 22 selects the operation assistant A4 as a slave operation assistant. The operation assistant A1 exchanges information with the operation assistant A4 serving as the slave operation assistant to control execution of the instructed function.

When the number of devices controllable by the operation assistant A4 is equal to the number of devices controllable by the operation assistant A5, the assistant control unit 22 may randomly select any one of the operation assistants A4 and A5 as a slave operation assistant, may select an operation assistant having a larger number of controllable functions as a slave operation assistant, may select an operation assistant having less load as a slave operation assistant, or may select an operation assistant that is not currently performing a process as a slave operation assistant.

As still another example, when information indicating a connection request is transmitted from the device 10F to the device 10A, the assistant control unit 22 may select a slave operation assistant from among the operation assistants A4 and A5 included in the device 10A on the basis of the number of controllable functions. For example, the assistant control unit 22 selects the operation assistant having the largest number of controllable functions as a slave operation assistant.

When the number of functions controllable by the operation assistant A4 is equal to the number of functions controllable by the operation assistant A5, the assistant control unit 22 may randomly select any one of the operation assistants A4 and A5 as a slave operation assistant, may select an operation assistant having a larger number of controllable devices as a slave operation assistant, may select an operation assistant having less load as a slave operation assistant, or may select an operation assistant that is not currently performing a process as a slave operation assistant.

If permission is obtained from a user associated with a user account that is currently logged into the operation assistants A4 and A5 in the requested device 10A, the assistant control unit 22 may select a slave operation assistant. If the permission is not obtained, the assistant control unit 22 does not select a slave operation assistant.

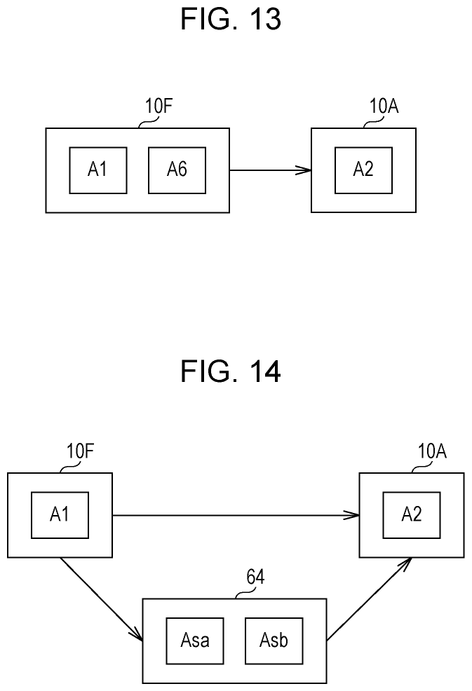

In the example illustrated in FIG. 11, the requested device 10A includes a plurality of operation assistants. Alternatively, the requesting device 10F may include a plurality of operation assistants. For example, as illustrated in FIG. 13, the requesting device 10F includes operation assistants A1 and A6. The requested device 10A includes the operation assistant A2.

When the device 10F transmits information indicating a connection request to the device 10A, as in Examples described above, the operation assistant A2 included in the device 10A is set as a slave operation assistant. Further, the assistant control unit 22 may select a master operation assistant from among the operation assistants A1 and A6 included in the device 10F.

For example, the assistant control unit 22 may select an operation assistant capable of controlling the target function to be executed (a standalone function or a collaborative function) as a master operation assistant. A specific example will be described. When a user provides an instruction to execute the image forming functions as a standalone function or to execute a collaborative function using the image forming functions, the assistant control unit 22 selects an operation assistant capable of controlling the image forming functions from among the operation assistants A1 and A6 as a master operation assistant. When the operation assistant A1 is capable of controlling the image forming functions and the operation assistant A6 is incapable of controlling the image forming functions, the assistant control unit 22 selects the operation assistant A1 as a master operation assistant. In this case, the operation assistant A1 exchanges information with the operation assistant A2 to control execution of the instructed function. For example, the assistant control unit 22 executes an operation assistant program for the operation assistant A1 to activate the operation assistant A1, sets the operation assistant A1 as a master operation assistant, and finishes an operation assistant program for the operation assistant A6 to disable the operation assistant A6.

When both the operation assistants A1 and A6 are capable of controlling the target function to be executed, the assistant control unit 22 may randomly select any one of the operation assistants A1 and A6 as a master operation assistant, may select an operation assistant having a larger number of controllable devices or functions as a master operation assistant, may select an operation assistant having less load as a master operation assistant, or may select an operation assistant that is not currently performing a process as a master operation assistant.

As another example, the assistant control unit 22 may select a master operation assistant on the basis of the number of controllable devices. For example, the assistant control unit 22 selects the operation assistant having the largest number of controllable devices as a master operation assistant. When the operation assistant A1 is capable of controlling a larger number of devices than the operation assistant A6, the assistant control unit 22 selects the operation assistant A1 as a master operation assistant. In this case, the operation assistant A1 exchanges information with the operation assistant A2 to control execution of the instructed function.

When the number of devices controllable by the operation assistant A1 is equal to the number of devices controllable by the operation assistant A6, the assistant control unit 22 may randomly select any one of the operation assistants A1 and A6 as a master operation assistant, may select an operation assistant having a larger number of controllable functions as a master operation assistant, may select an operation assistant having less load as a master operation assistant, or may select an operation assistant that is not currently performing a process as a master operation assistant.

As still another example, the assistant control unit 22 may select a master operation assistant on the basis of the number of controllable functions. For example, the assistant control unit 22 selects the operation assistant having the largest number of controllable functions as a master operation assistant.

When the number of functions controllable by the operation assistant A1 is equal to the number of functions controllable by the operation assistant A6, the assistant control unit 22 may randomly select any one of the operation assistants A1 and A6 as a master operation assistant, may select an operation assistant having a larger number of controllable devices as a master operation assistant, may select an operation assistant having less load as a master operation assistant, or may select an operation assistant that is not currently performing a process as a master operation assistant.

As illustrated in FIG. 14, the external device 64 may include a plurality of standard operation assistants. In the example illustrated in FIG. 14, the external device 64 includes standard operation assistants Asa and Asb. As in the selection of a slave operation assistant and a master operation assistant, the assistant control unit 22 selects a standard operation assistant that controls a slave operation assistant from among the standard operation assistants Asa and Asb on the basis of a controllable device or devices, the number of controllable devices, a controllable function or functions, or the number of controllable functions.

The selection of a slave operation assistant, the selection of a master operation assistant, and the selection of a standard operation assistant may be performed by the assistant control unit 22 of the device 10F, by the assistant control unit 22 of the device 10A, or by the assistant control unit 22 of an external device such as a server. Further, the information illustrated in FIG. 12 may be stored in each of the devices 10 or may be stored in an external device such as a server.

Note that all of the devices 10 included in the information processing system may include a plurality of operation assistants, or some of the devices 10 included in the information processing system may include a plurality of operation assistants and the other devices 10 may include a single operation assistant. For example, devices 10 such as a smartphone and a smart speaker may include a plurality of operation assistants, and devices 10 such as a sensor and a household electrical appliance may include a single operation assistant (an operation assistant unique to each of the devices 10 such as a sensor and a household electrical appliance).

According to Example 1-5, even when the device 10 includes a plurality of operation assistants, a master-slave relationship between a plurality of operation assistants may be appropriately set up and functions may be executed.

### EXAMPLE 1-6

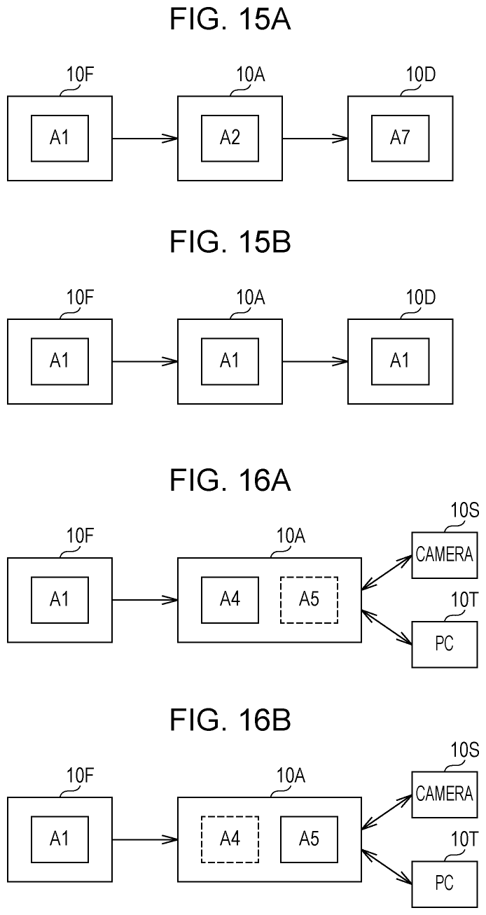

A process according to Example 1-6 will be described with reference to FIGS. 15A and 15B. FIGS. 15A and 15B illustrate an example of the devices 10.

For example, the device 10F includes the operation assistant A1. The device 10A includes the operation assistant A2. The device 10D includes an operation assistant A7.

As illustrated in FIG. 15A, when information indicating a connection request is transmitted from the device 10F to the device 10A, the operation assistant A1 included in the device 10F operates as a master operation assistant and the operation assistant A2 included in the device 10A operates as a slave operation assistant. For example, as illustrated in FIG. 15B, the operation assistant enabled on the device 10A is switched from the operation assistant A2 to the operation assistant A1. It is to be understood that processes similar to those in Examples 1-1 and 1-2 described above may be performed without switching the operation assistant enabled on the device 10A.

When information indicating a connection request is transmitted from the device 10A to the device 10D, the operation assistant A7 included in the device 10D operates as a slave operation assistant that recognizes the operation assistant enabled on the device 10A (e.g., the operation assistant A1 after switching) as a master operation assistant. For example, as illustrated in FIG. 15B, the operation assistant enabled on the device 10D is switched from the operation assistant A6 to the operation assistant A1.

As described above, when three or more devices 10 are connected, operation assistants included in devices 10 that have received information indicating a connection request are set one after another as slave operation assistants. Accordingly, the devices 10 may be controlled appropriately.

### EXAMPLE 1-7

A process according to Example 1-7 will be described with reference to FIGS. 16A and 16B. FIGS. 16A and 16B illustrate an example of the devices 10. In Example 1-7, as in Example 1-1, the device 10F corresponds to the requesting device, and the device 10A corresponds to the requested device.

As illustrated in FIG. 16A, the requested device 10A includes a plurality of operation assistants. For example, the device 10A includes operation assistants A4 and A5. The requesting device 10F includes the operation assistant A1. Further, the device 10A is connected to devices 10S and 10T as third devices, as an example. The device 10S is a camera having the image capturing function, and the device 10T is a PC.

For example, the device 10S is a device corresponding to the operation assistant A5. That is, the device 10S is a device controllable by the operation assistant A5. The device 10T is a device corresponding to the operation assistant A4. That is, the device 10T is a device controllable by the operation assistant A4. In this way, for each device, an operation assistant capable of corresponding to the device is set. Note that each of the devices 10S and 10T may or may not include an operation assistant.

An operation assistant capable of corresponding to a device may be determined for each type of operation assistant or may be determined for each user account. For example, an operation assistant of a type identical to that of the operation assistant A5 may be capable of controlling the device 10S in a way similar to that of the operation assistant A5, or even an operation assistant of a type identical to that of the operation assistant A5 may be incapable of controlling the device 10S if the operation assistant is used by a user account different from that of the operation assistant A5. Whether an operation assistant is capable of corresponding to a device may be determined based on the version of the operation assistant. The same applies to the operation assistant A4.

When information indicating a connection request is transmitted from the device 10F to the device 10A, the assistant control unit 22 selects an operation assistant capable of controlling a third device from among the operation assistants A4 and A5 included in the device 10A as a slave operation assistant. For example, when the device 10S is designated by a user as a third device to be used or when a function included in the device 10S (e.g., the image capturing functions) is designated by the user, the assistant control unit 22 selects the operation assistant A5 capable of controlling the device 10S as a slave operation assistant.

For example, when the operation assistant A4 is enabled on the device 10A, the assistant control unit 22 switches the operation assistant enabled on the device 10A from the operation assistant A4 to the operation assistant A5. In the example illustrated in FIG. 16A, the operation assistant A4 is activated, whereas the operation assistant A5 is not activated. The operation assistant A4, which is currently activated, is depicted by a solid line, and the operation assistant A5, which is not activated, is depicted by a broken line. For example, an operation assistant program for the operation assistant A4 is executed and the operation assistant A4 is being activated, whereas an operation assistant program for the operation assistant A5 is not executed and the operation assistant A5 is not activated.

When the operation assistant A5 is selected as a slave operation assistant in the state illustrated in FIG. 16A, as illustrated in FIG. 16B, the assistant control unit 22 completes activation of the operation assistant A4 and activates the operation assistant A5. In FIG. 16B, the operation assistant A5, which is currently activated, is depicted by a solid line, and the operation assistant A4, which is not activated, is depicted by a broken line. For example, the operation assistant program for the operation assistant A5 is executed and the operation assistant A5 is being activated, whereas execution of the operation assistant program for the operation assistant A4 is finished and the operation assistant A4 is not in operation.

The operation assistant A5 serving as the slave operation assistant operates in accordance with an instruction from the master operation assistant. In the example described above, the operation assistant A5 controls the device 10S. For example, the operation assistant A5 acquires image data generated by capturing an image with the device 10S from the device 10S and transmits the image data to the requesting device 10F.

The master operation assistant may be the operation assistant A1 included in the device 10F or may be another operation assistant included in an external device.

When both the operation assistants A4 and A5 are capable of controlling the device 10S, the assistant control unit 22 may select any one of the operation assistants A4 and A5 as a slave operation assistant, may select an operation assistant having a larger number of controllable devices or functions as a slave operation assistant, may select an operation assistant having less load as a slave operation assistant, or may select an operation assistant that is not currently performing a process as a slave operation assistant. Alternatively, a slave operation assistant may be selected in accordance with a standard similar to that in Example 1-5.

The selection of a slave operation assistant and the selection of a master operation assistant may be performed by the assistant control unit 22 of the device 10F, by the assistant control unit 22 of the device 10A, or by the assistant control unit 22 of an external device such as a server.

According to Example 1-7, an operation assistant capable of corresponding to the device 10 to be used is selected as a slave operation assistant, and thus the device 10 may be appropriately controlled.

For example, when a user account that is currently logged into an operation assistant in the requesting device is different from a user account that is currently logged into an operation assistant in the requested device or when an operation assistant in the requesting device and an operation assistant in the requested device are operation assistants of different types, it may be difficult for the operation assistant in the requesting device and the operation assistant in the requested device to exchange messages. As a result, it may be difficult for the corresponding devices to work in collaboration. Even in this case, the first exemplary embodiment may enable the operation assistant in the requesting device and the operation assistant in the requested device to exchange messages and may thus enable the corresponding devices to work in collaboration.

### Second Exemplary Embodiment

The following describes an information processing system according to a second exemplary embodiment of the present disclosure. Similarly to the information processing system according to the first exemplary embodiment, the information processing system according to the second exemplary embodiment includes one or more devices 10. Further, the device 10 according to the second exemplary embodiment has the same or substantially the same configuration as the device 10 according to the first exemplary embodiment.

In the second exemplary embodiment, the requesting device 10 includes a plurality of operation assistants. The plurality of operation assistants are operation assistants of different types. For example, the plurality of operation assistants are operation assistants having different types of artificial intelligence (AI). As another example, even if the plurality of operation assistants are operation assistants of an identical type (e.g., even if the plurality of operation assistants have an identical type of AI), the plurality of operation assistants may be handled as different operation assistants when the versions are different, when controllable devices or functions are different, when users available are different, or when the login user accounts are different.

The assistant control unit 22 of the requesting device 10 is configured to, when the requesting device 10 is given an operation instruction directed to another device 10 by a user, select an operation assistant capable of controlling the other device 10 from among the plurality of operation assistants included in the requesting device 10 (an example of an information processing apparatus) and transmit information indicating an operation instruction from the selected operation assistant to the other device 10.

The other device 10 described above may or may not include an operation assistant. Further, the other device 10 may be a device connected directly to the requesting device 10 or may be a device connected indirectly to the requesting device 10 via a device such as a relay.

In the second exemplary embodiment, no master-slave relationship is set up between operation assistants. That is, no master operation assistant or slave operation assistant is set.

The following describes some examples according to the second exemplary embodiment in detail.

### EXAMPLE 2-1

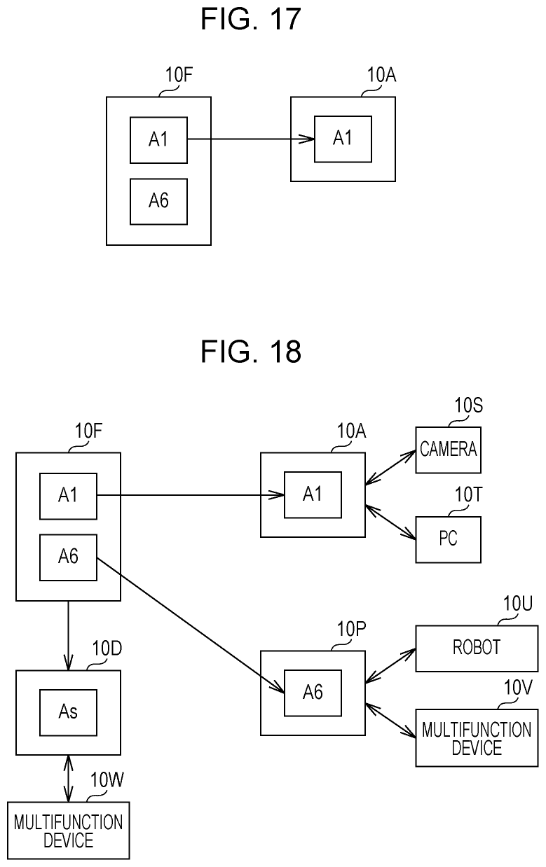

A process according to Example 2-1 will be described with reference to FIG. 17. FIG. 17 illustrates an example of the devices 10. In Example 2-1, the device 10F is the requesting device. The device 10A is the requested device and an operation target device. That is, the device 10F transmits information indicating an operation instruction to the device 10A. For example, the device 10F transmits information indicating an operation instruction to the device 10A when a standalone function included in the device 10A is executed, when the device 10F is used to set a standalone function in the device 10A, when the device 10F and the device 10A work in collaboration to execute a collaborative function, when the device 10F is used to set a collaborative function in the device 10A, when the device 10F is used to set a collaborative function in another device 10 through the device 10A, when the device 10A is used through the device 10F, or when a user gives an instruction to transmit an operation instruction by using the device 10F. It is to be understood that the device 10F may transmit information indicating an operation instruction to the device 10A when any other event occurs. A user may give an operation instruction directed to the device 10 without designating an operation assistant.

The device 10F includes the operation assistants A1 and A6. The device 10A includes the operation assistant A1. The operation assistants A1 and A6 are operation assistants of different types, for example. For example, the operation assistants A1 and A6 are operation assistants having different types of artificial intelligence (AI). As another example, even if the operation assistants A1 and A6 are operation assistants of an identical type (e.g., even if the operation assistants A1 and A6 have an identical type of AI), the operation assistants A1 and A6 may be handled as different operation assistants when the versions are different, when controllable functions or devices are different, when users available are different, or when the login user accounts are different.

Further, the operation assistant A1 included in the device 10F and the operation assistant A1 included in the device 10A are operation assistants of an identical type. As another example, the operation assistant A1 included in the device 10F and the operation assistant A1 included in the device 10A may be operation assistants of an identical type, but may have different versions, may have different controllable functions or devices, or may be available to different users, or different user accounts may be logging in.

Further, each of the devices 10 stores management information. The management information includes assistant identification information for identifying operation assistants included in the devices 10. The assistant control unit 22 of each of the devices 10 refers to the assistant identification information included in the management information to identify the operation assistants included in the devices 10. For example, each of the devices 10 transmits and receives assistant identification information for identifying an operation assistant included therein, so that the management information is updated at any timing, periodically, or at the timing designated by a user. It is to be understood that the management information may be stored in a device such as a server and the assistant control unit 22 may refer to the management information stored in the device such as a server to identify the operation assistants included in the devices 10.

For example, device identification information for identifying the device 10F and assistant identification information for identifying the operation assistants A1 and A6 included in the device 10F are registered in the management information in association with each other. Information concerning operation assistants included in the other devices 10 is also registered in the management information in a similar manner.

When the device 10F transmits information indicating an operation instruction to the device 10A, the assistant control unit 22 of the device 10F refers to the management information and selects an operation assistant capable of controlling the device 10A from among the operation assistants A1 and A6 included in the device 10F. More specifically, the assistant control unit 22 refers to the management information to identify the operation assistant A1 included in the requested device 10A, and selects an operation assistant capable of interacting with the operation assistant A1 included in the device 10A from among the operation assistants A1 and A6 included in the device 10F. That is, the assistant control unit 22 selects an operation assistant capable of exchanging messages with the operation assistant A1 included in the device 10A. For example, an operation assistant of a type identical to that of the operation assistant A1 included in the device 10A is an operation assistant capable of exchanging messages with the operation assistant A1. Accordingly, the assistant control unit 22 selects the operation assistant A1 from among the operation assistants A1 and A6 included in the device 10F as an operation assistant capable of controlling the device 10A.

The assistant control unit 22 transmits information indicating an operation instruction from the operation assistant A1 included in the device 10F to the device 10A. That is, the operation assistant A1 included in the device 10F transmits information indicating an operation instruction to the operation assistant A1 included in the device 10A. The operation assistant A1 included in the device 10A receives the information indicating an operation instruction, which is transmitted from the operation assistant A1 included in the device 10F, and controls the device 10A in accordance with the operation instruction.

For example, the information indicating an operation instruction includes information indicating a process executable using the device 10A. The operation assistant A1 included in the device 10A causes the device 10A to execute the process in accordance with the operation instruction.

According to Example 2-1, when the requesting device 10 includes a plurality of operation assistants, an operation assistant capable of controlling the requested device 10 is selected from among the plurality of operation assistants, and information indicating an operation instruction is transmitted from the selected operation assistant to the requested device 10. This may allow a user operating the requesting device 10 to give an operation instruction without being aware of the operation assistant included in the requested device 10 or the requesting device 10, resulting in an improvement in the operability of the devices 10 or the operation assistants. For example, the user does not need to manually designate an operation assistant capable of controlling the operation target device 10, and operability may be improved.

### EXAMPLE 2-2

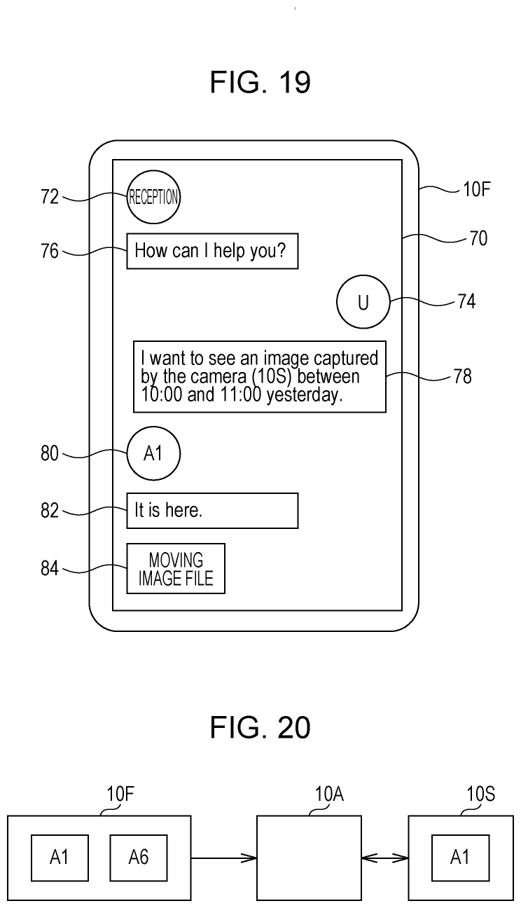

A process according to Example 2-2 will be described with reference to FIGS. 18 and 19. FIG. 18 illustrates an example of the devices 10. FIG. 19 illustrates an example of a screen for exchanging messages between a user and an operation assistant.

The device 10A is connected to the device 10S serving as a camera and the device 10T serving as a PC. The device 10P is connected to a device 10U serving as a robot and a device 10V serving as a multifunction device. The device 10D is connected to a device 10W serving as a multifunction device. The devices 10A, 10P, and 10D are relays. The device 10F is the requesting device. In Example 2-2, the operation target device 10 is operated through a relay.

The device 10F includes the operation assistants A1 and A6. The device 10A includes the operation assistant A1. The device 10P includes the operation assistant A6. The device 10D includes the standard operation assistant As. The standard operation assistant As has a function common to, for example, the operation assistants A1 and A6.

Each of the devices 10S, 10T, 10U, 10V, and 10W may or may not include an operation assistant.

The device 10S is a device corresponding to the operation assistants A1, A2, A3, and A6. That is, the device 10S is a device controllable by each of the operation assistants A1, A2, A3, and A6. The device 10S is connected to the device 10A and is controlled by the operation assistant A1 included in the device 10A.

The device 10T is a device corresponding to the operation assistants A1 and A2. That is, the device 10T is a device controllable by each of the operation assistants A1 and A2. The device 10T is connected to the device 10A and is controlled by the operation assistant A1 included in the device 10A.

The device 10U is a device corresponding to the operation assistants A1 and A6. That is, the device 10U is a device controllable by each of the operation assistants A1 and A6. The device 10U is connected to the device 10P and is controlled by the operation assistant A6 included in the device 10P.

The device 10V is a device corresponding to the operation assistant A6. That is, the device 10V is a device controllable by the operation assistant A6. The device 10V is connected to the device 10P and is controlled by the operation assistant A6 included in the device 10P.

The device 10W is a device corresponding to the operation assistants A1, A3, and As. That is, the device 10W is a device controllable by the operation assistants A1, A3, and As. The device 10W is connected to the device 10D and is controlled by the operation assistant As included in the device 10D.

The following describes a process according to Example 2-2 in detail with reference to FIG. 19. The control unit 20 of the device 10F causes a display unit of the UI unit 14 to display a screen 70. The screen 70 is a user interface for exchanging messages between a user and an operation assistant. The screen 70 has an operation assistant display area that displays an image 72 associated with an operation assistant. The screen 70 also has a user display area that displays an image 74 associated with a user. The image 72 is not an image representing a specific operation assistant, but an image indicating that the user is interacting with an operation assistant. For example, the image 72 is an image associated with a reception desk that receives utterances produced by the user.

On the screen 70, an interaction is carried out between the user and the operation assistant. At this time, the interaction partner may be the operation assistant A1 or A6 included in the device 10F or an operation assistant that is being activated at the timing of the interaction.

During the interaction, the content of an utterance 76 produced by the operation assistant is displayed in association with the image 72, and the content of an utterance 78 produced by the user is displayed in association with the image 74.

For example, when the user gives an operation instruction directed to the device 10S (camera) through the utterance 78, the assistant control unit 22 of the device 10F searches for the device 10A, which is a device (relay) connected to the device 10S and including an operation assistant capable of controlling the device 10S and which includes at least one of the operation assistants A1 and A6 included in the requesting device 10F, as the requested device 10. At this time, the user may give an operation instruction directed to the device 10S without designating an operation assistant. The following describes this process in detail.

For example, the management information described above further includes device identification information for identifying another device 10 connected to each of the devices 10, and assistant identification information for identifying an operation assistant capable of controlling the other device 10 (an operation assistant corresponding to the other device 10).

A specific example will be described. In the management information, device identification information for identifying the device 10A, device identification information for identifying the device 10S connected to the device 10A, assistant identification information for identifying each of the operation assistants A1, A2, A3, and A6 capable of controlling the device 10S, device identification information for identifying the device 10T connected to the device 10A, and assistant identification information for identifying each of the operation assistants A1 and A2 capable of controlling the device 10T are registered in association with each other.

Likewise, in the management information, device identification information for identifying the device 10P, device identification information for identifying the device 10U connected to the device 10P, assistant identification information for identifying each of the operation assistants A1 and A6 capable of controlling the device 10U, device identification information for identifying the device 10V connected to the device 10P, and assistant identification information for identifying the operation assistant A6 capable of controlling the device 10V are registered in association with each other.

Likewise, device identification information for identifying the device 10D, device identification information for identifying the device 10W connected to the device 10D, and assistant identification information for identifying each of the operation assistants A1, A3, and As capable of controlling the device 10W are associated with each other.

Further, as described above, the device identification information for identifying the device 10A and assistant identification information for identifying the operation assistant A1 included in the device 10A are registered in the management information in association with each other.

Likewise, the device identification information for identifying the device 10P and assistant identification information for identifying the operation assistant A6 included in the device 10P are registered in the management information in association with each other.

Likewise, the device identification information for identifying the device 10D and assistant identification information for identifying the operation assistant As included in the device 10D are registered in the management information in association with each other.

The assistant control unit 22 of the device 10F refers to the management information described above to search for the device 10A, which is a device connected to the device 10S and including an operation assistant capable of controlling the device 10S and which includes at least one of the operation assistants A1 and A6 included in the requesting device 10F, as the requested device 10. That is, the device 10A is connected to the operation target device 10S and includes the operation assistant A1 capable of controlling the device 10S. Further, the device 10A includes the operation assistant A1 included in the requesting device 10F. Accordingly, the assistant control unit 22 selects the device 10A as the requested device.

Further, the assistant control unit 22 of the device 10F selects the operation assistant A1 capable of controlling the device 10S from among the operation assistants A1 and A6 included in the device 10F. That is, the assistant control unit 22 of the device 10F selects an operation assistant capable of exchanging messages with the operation assistant A1 included in the requested device 10A (the operation assistant A1 capable of controlling the device 10S) from among the operation assistants A1 and A6. For example, an operation assistant of a type identical to that of the operation assistant A1 included in the device 10A is the operation assistant capable of exchanging messages with the operation assistant A1. Accordingly, the assistant control unit 22 selects the operation assistant A1 as an operation assistant capable of controlling the device 10S from among the operation assistants A1 and A6 included in the device 10F.

The assistant control unit 22 transmits information indicating an operation instruction directed to the device 10S from the operation assistant A1 included in the device 10F to the operation assistant A1 included in the device 10A.

The operation assistant A1 included in the device 10A controls the device 10S in accordance with the operation instruction. For example, when the operation instruction has content indicating that the user desires to see an image captured by the device 10S between 10:00 a.m. and 11:00 a.m. yesterday, the operation assistant A1 included in the device 10A acquires the image data from the device 10S. Further, the operation assistant A1 included in the device 10A transmits the image data to the operation assistant A1 included in the device 10F. The image data is provided to the user on the device 10F.

When the operation assistant A1 is selected as an operation assistant capable of controlling the device 10S on the device 10F, as illustrated in FIG. 19, in the subsequent interaction, the control unit 20 switches the image 72 associated with the operation assistant to an image 80 associated with the operation assistant A1. The content of an utterance 82 produced by the operation assistant A1 is displayed in association with the image 80.

Further, the control unit 20 controls notification of an operation result of the device 10S. For example, as illustrated in FIG. 19, the control unit 20 displays an image 84 (e.g., an icon) associated with the image data (e.g., a moving image file) acquired from the device 10S as an operation result of the device 10S on the screen 70 in association with the image 80. When a reproduction instruction is given with the image 84 being designated, the moving image file is reproduced.

When the operation of the device 10S is completed, the control unit 20 switches the image 80 associated with the operation assistant A1 back to the image 72 again.

The control unit 20 may display a character string for identifying the operation assistant A1 (e.g., the name of the operation assistant A1) instead of or in addition to the image 80, on the screen 70. Further, the content of the utterance 82 associated with the operation assistant A1 may include a character string for identifying the operation assistant A1. The same applies to the image 72 associated with the reception desk or the image 74 associated with the user.

Further, when the user gives an operation instruction directed to the device 10U (robot), the assistant control unit 22 of the device 10F refers to the management information described above to search for the device 10P, which is a device (relay) connected to the device 10U and including an operation assistant capable of controlling the device 10U and which includes at least one of the operation assistants A1 and A6 included in the requesting device 10F, as the requested device 10. That is, the device 10P is connected to the operation target device 10U and includes the operation assistant A6 capable of controlling the device 10U. Further, the device 10P includes the operation assistant A6 included in the requesting device 10F. Accordingly, the assistant control unit 22 selects the device 10P as the requested device.

Further, the assistant control unit 22 of the device 10F selects the operation assistant A6 capable of controlling the device 10U from among the operation assistants A1 and A6 included in the device 10F. That is, the assistant control unit 22 of the device 10F selects an operation assistant capable of exchanging messages with the operation assistant A6 included in the requested device 10P (the operation assistant A6 capable of controlling the device 10U) from among the operation assistants A1 and A6. For example, an operation assistant of a type identical to that of the operation assistant A6 included in the device 10P is the operation assistant capable of exchanging messages with the operation assistant A6. Accordingly, the assistant control unit 22 selects the operation assistant A6 as an operation assistant capable of controlling the device 10U from among the operation assistants A1 and A6 included in the device 10F.

The assistant control unit 22 transmits information indicating an operation instruction directed to the device 10U from the operation assistant A6 included in the device 10F to the operation assistant A6 included in the device 10P. The operation assistant A6 included in the device 10P controls the device 10U in accordance with the operation instruction. Further, the control unit 20 controls notification of an operation result of the device 10U.

Further, when the user gives an operation instruction directed to the device 10W (multifunction device), the assistant control unit 22 of the device 10F refers to the management information described above to search for the device 10D, which is a device (relay) connected to the device 10W and including an operation assistant capable of controlling the device 10W and which includes at least one of the operation assistants A1 and A6 included in the requesting device 10F, as the requested device 10. That is, the device 10D is connected to the operation target device 10W and includes the operation assistant As capable of controlling the device 10W. Further, the device 10D includes the standard operation assistant As capable of interacting with the operation assistants A1 and A6 included in the requesting device 10F. Accordingly, the assistant control unit 22 selects the device 10D as the requested device.

Further, the assistant control unit 22 of the device 10F selects an operation assistant capable of controlling the device 10W from among the operation assistants A1 and A6 included in the device 10F. That is, the assistant control unit 22 of the device 10F selects an operation assistant capable of exchanging messages with the operation assistant As included in the requested device 10D from among the operation assistants A1 and A6. Both the operation assistants A1 and A6 are capable of exchanging messages with the standard operation assistant As. Thus, the assistant control unit 22 selects any one of the operation assistants A1 and A6 as an operation assistant capable of controlling the device 10W. For example, the assistant control unit 22 selects, as an operation assistant capable of controlling the device 10W, an operation assistant that is not currently performing a process, an operation assistant having a larger number of functions common to the standard operation assistant As, an operation assistant having less load, or the like from among the operation assistants A1 and A6. Here, as an example, the operation assistant A1 is assumed to be selected.

The assistant control unit 22 transmits information indicating an operation instruction directed to the device 10W from the operation assistant A1 included in the device 10F to the standard operation assistant As included in the device 10D. The standard operation assistant As included in the device 10D controls the device 10W in accordance with the operation instruction. Further, the control unit 20 controls notification of an operation result of the device 10W.

According to Example 2-2, as in Example 2-1, the user operating the requesting device 10 may be able to give an operation instruction without being aware of the operation assistant included in the requested device 10 or the requesting device 10. Thus, the operability of the devices 10 or the operation assistants may be improved.

### EXAMPLE 2-3

A process according to Example 2-3 will be described with reference to FIG. 20. FIG. 20 illustrates an example of the devices 10. In Example 2-3, the device 10F is the requesting device. The device 10A is a relay. The device 10A is connected to the device 10S.

The device 10F includes the operation assistants A1 and A6. The device 10A includes no operation assistant. The device 10S includes the operation assistant A1. In Example 2-3, the operation target device 10S is operated through the device 10A serving as a relay.

When the device 10F transmits information indicating an operation instruction for operating the device 10S to the device 10S through the device 10A, the assistant control unit 22 of the device 10F refers to the management information and selects an operation assistant capable of controlling the device 10S from among the operation assistants A1 and A6 included in the device 10F. More specifically, the assistant control unit 22 refers to the management information to identify the operation assistant A1 included in the requested device 10S, and selects an operation assistant capable of interacting with the operation assistant A1 included in the device 10S from among the operation assistants A1 and A6 included in the device 10F. That is, the assistant control unit 22 selects an operation assistant capable of exchanging messages with the operation assistant A1 included in the device 10S. For example, the assistant control unit 22 selects the operation assistant A1 as an operation assistant capable of controlling the device 10S from among the operation assistants A1 and A6 included in the device 10F.

The assistant control unit 22 transmits information indicating an operation instruction from the operation assistant A1 included in the device 10F to the device 10S. That is, the operation assistant A1 included in the device 10F transmits information indicating an operation instruction to the operation assistant A1 included in the device 10S. The information indicating an operation instruction is transmitted from the device 10F to the device 10S via the device 10A serving as a relay. The operation assistant A1 included in the device 10S receives the information indicating an operation instruction, which is transmitted from the operation assistant A1 included in the device 10F, and controls the device 10S in accordance with the operation instruction.

For example, the information indicating an operation instruction includes information indicating a process executable using the device 10S. The operation assistant A1 included in the device 10A causes the device 10A to execute the process in accordance with the operation instruction.

According to Example 2-3, also when the device 10 including an operation assistant is controlled through a relay including no operation assistant, the user operating the requesting device 10 may be able to give an operation instruction without being aware of the operation assistant included in the requesting device 10 or the requested device 10.

### EXAMPLE 2-4

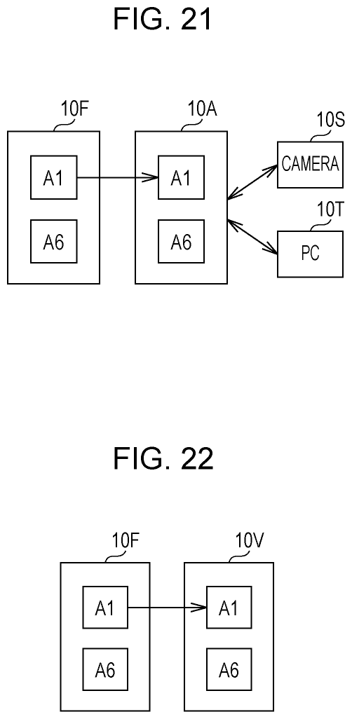

A process according to Example 2-4 will be described with reference to FIG. 21. FIG. 21 illustrates an example of the devices 10. In Example 2-4, the device 10F is the requesting device. The device 10A is the requested device and is used as a relay. The device 10A is connected to the devices 10S and 10T.

The device 10F includes the operation assistants A1 and A6. The device 10A includes the operation assistants A1 and A6. In this way, in Example 2-4, the device 10A serving as a relay also includes a plurality of operation assistants. Each of the devices 10S and 10T includes no operation assistant.

The device 10S is a device corresponding to the operation assistant A1. That is, the device 10S is a device controllable by the operation assistant A1. The device 10S is connected to the device 10A and is controlled by the operation assistant A1 included in the device 10A.

The device 10T is a device corresponding to the operation assistant A6. That is, the device 10T is a device controllable by the operation assistant A6. The device 10T is connected to the device 10A and is controlled by the operation assistant A6 included in the device 10A.

When the device 10F transmits information indicating an operation instruction for operating the device 10S to the device 10A, the assistant control unit 22 of the device 10F refers to the management information to specify the operation assistant A1 capable of controlling the device 10S from among the operation assistants A1 and A6 included in the device 10A. The assistant control unit 22 selects the operation assistant A1 capable of interacting with the operation assistant A1 included in the device 10A as an operation assistant capable of controlling the device 10S from among the operation assistants A1 and A6 included in the device 10F.

The assistant control unit 22 transmits information indicating an operation instruction from the operation assistant A1 included in the device 10F to the operation assistant A1 included in the device 10A. The operation assistant A1 included in the device 10A receives the information indicating an operation instruction, which is transmitted from the operation assistant A1 included in the device 10F, and controls the device 10S in accordance with the operation instruction. That is, the assistant control unit 22 selects the operation assistant A1 as an operation assistant capable of controlling the device 10S connected to the device 10A from among the operation assistants A1 and A6 included in the device 10F, and transmits information indicating an operation instruction from the selected operation assistant A1 to the operation assistant A1 included in the device 10A.

According to Example 2-4, also when the requested device 10 includes a plurality of operation assistants, the user operating the requesting device 10 may be able to give an operation instruction without being aware of the operation assistant included in the requesting device 10 or the requested device 10.

Note that the operation assistant A1 included in the device 10F may send a message to the operation assistant A1 included in the device 10A and also send a message to the operation assistant A6 included in the device 10A in accordance with a protocol that can be interpreted by the operation assistant A6 included in the device 10A.

### EXAMPLE 2-5

A process according to Example 2-5 will be described. Information indicating an operation instruction includes information indicating an instruction for executing a target function to be executed by the requested device 10. The instruction for executing the function is provided by the user operating the requesting device 10. The assistant control unit 22 of the requesting device 10 selects an operation assistant capable of providing the instruction for executing the function to the requested device 10 as an operation assistant capable of controlling the requested device 10. The assistant control unit 22 transmits information indicating an operation instruction from the selected operation assistant to the requested device 10. The requested device 10 executes the function in accordance with the instruction for executing the function, which is included in the operation instruction.

For example, a controllable function is determined for each operation assistant, and information indicating functions controllable by the respective operation assistants is included in the management information described above. Specifically, in the management information, for each operation assistant, assistant identification information for identifying the operation assistant and function information indicating a function controllable by the operation assistant are registered in association with each other. The assistant control unit 22 refers to the management information and selects an operation assistant capable of controlling a function indicated by an operation instruction.

The following describes Example 2-5 with reference to a specific example. The requesting device 10 includes the operation assistants A1 and A6. The requested device 10 is a multifunction device having the image forming functions such as the printing function.

The operation assistant A1 is capable of controlling execution of the image forming functions included in a multifunction device. The operation assistant A6 is capable of controlling execution of the image capturing function included in a camera.

For example, when a user provides an instruction to execute the printing function using the requested device 10 by using the requesting device 10, the assistant control unit 22 selects the operation assistant A1 capable of controlling execution of the printing function from among the operation assistants A1 and A6 included in the requesting device 10. The assistant control unit 22 transmits information indicating an operation instruction including an instruction for executing the printing function from the selected operation assistant A1 to the requested device 10. That is, the operation assistant A1 controls the requested device 10 in accordance with the operation instruction to cause the requested device 10 to execute the printing function. The requested device 10 executes the printing function in accordance with the instruction for executing the printing function.

According to Example 2-5, when an instruction is given to execute a function, information indicating an operation instruction is transmitted from an operation assistant capable of controlling the function to a device that executes the function. Thus, the user operating the requesting device 10 may be able to give an operation instruction without being aware of the operation assistant included in the requesting device 10.

### EXAMPLE 2-6

A process according to Example 2-6 will be described with reference to FIG. 22. FIG. 22 illustrates an example of the devices 10. In Example 2-6, the device 10F is the requesting device. The device 10V is the requested device.

The device 10F includes the operation assistants A1 and A6. The device 10V includes the operation assistants A1 and A6. In this way, in Example 2-6, the requested device 10V also includes a plurality of operation assistants.

As in Example 2-5, information indicating an operation instruction includes information indicating an instruction for executing a target function to be executed by the requested device 10V. The instruction for executing the function is provided by the user operating the requesting device 10F. The assistant control unit 22 of the requesting device 10F selects an operation assistant capable of controlling the function from among the plurality of operation assistants included in the requested device 10V. Further, the assistant control unit 22 of the requesting device 10F selects an operation assistant capable of interacting with the selected operation assistant as an operation assistant capable of controlling the requested device 10 from among the plurality of operation assistants included in the requesting device 10F.

The following describes Example 2-6 with reference to a specific example. The requested device 10V is a multifunction device having the image forming functions such as the printing function. The operation assistant A1 is capable of controlling execution of the image forming functions included in a multifunction device. The operation assistant A6 is capable of controlling execution of the image capturing function included in a camera.

For example, when a user gives an instruction to execute the printing function using the requested device 10V by using the requesting device 10F, the assistant control unit 22 refers to the management information and selects the operation assistant A1 capable of controlling the printing function from among the operation assistants A1 and A6 included in the requested device 10V. Further, the assistant control unit 22 selects the operation assistant A1 capable of interacting with the operation assistant A1 included in the requested device 10V as an operation assistant capable of controlling the requested device 10V from among the operation assistants A1 and A6 included in the requesting device 10F.

The assistant control unit 22 transmits information indicating an operation instruction including an instruction for executing the printing function from the operation assistant A1 included in the device 10F to the operation assistant A1 included in the device 10V. The operation assistant A1 included in the device 10V receives the information indicating an operation instruction, which is transmitted from the operation assistant A1 included in the device 10F, and causes the device 10V to execute the printing function in accordance with the operation instruction.

According to Example 2-6, also when both the requesting device 10 and the requested device 10 include a plurality of operation assistants, the user operating the requesting device 10 may be able to give an instruction for executing a function without being aware of the operation assistants.

Further, in Example 2-4 described above (see FIG. 21), when a user designates a target function to be executed by the device 10S or the device 10T, the assistant control unit 22 selects an operation assistant capable of controlling the function from among the operation assistants A1 and A6 included in the device 10A. For example, when a user gives an instruction to execute the image capturing function using the device 10S (camera), the assistant control unit 22 selects the operation assistant A6 capable controlling the image capturing function from among the operation assistants A1 and A6 included in the device 10A. Further, the assistant control unit 22 selects the operation assistant A6 capable of interacting with the operation assistant A6 included in the requested device 10A as an operation assistant capable of controlling the requested device from among the operation assistants A1 and A6 included in the requesting device 10F.

The assistant control unit 22 transmits information indicating an operation instruction including an instruction for executing the image capturing function from the operation assistant A6 included in the device 10F to the operation assistant A6 included in the device 10A. The operation assistant A6 included in the device 10A receives the information indicating an operation instruction, which is transmitted from the operation assistant A6 included in the device 10F, and causes the device 10S to execute the image capturing function in accordance with the operation instruction.

Accordingly, also when Example 2-6 is applied to Example 2-4, the user operating the requesting device 10 may be able to give an instruction for executing a function without being aware of the operation assistants included in the devices 10.

### EXAMPLE 2-7

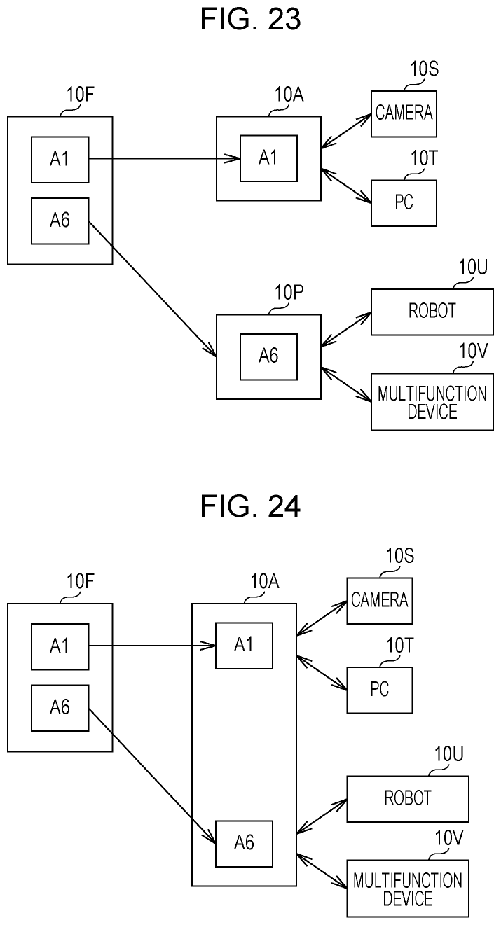

A process according to Example 2-7 will be described with reference to FIG. 23. FIG. 23 illustrates an example of the devices 10. In Example 2-7, an instruction is given by a user to execute a collaborative function, one or more operation assistants for executing the collaborative function are selected, and the one or more operation assistants control execution of the collaborative function. The following describes Example 2-7 in detail.

In Example 2-7, the device 10F is the requesting device. The devices 10A and 10P are requested devices and are used as relays. The device 10A is connected to the devices 10S and 10T. The device 10P is connected to the devices 10U and 10V.

The device 10F includes the operation assistants A1 and A6. The device 10A includes the operation assistant A1. The device 10P includes the operation assistant A6. Each of the devices 10S, 10T, 10U, and 10V includes no operation assistant.

In Example 2-7, the devices 10S and 10T are devices corresponding to the operation assistant A1. That is, the devices 10S and 10T are devices controllable by the operation assistant A1. The devices 10S and 10T are connected to the device 10A and are controlled by the operation assistant A1.

The devices 10U and 10V are devices corresponding to the operation assistant A6. That is, the devices 10U and 10V are devices controllable by the operation assistant A6. The devices 10U and 10V are connected to the device 10P and are controlled by the operation assistant A6.

For example, it is assumed that a user gives an instruction to execute an image capturing and printing function as a collaborative function by using the requesting device 10F. The image capturing and printing function is a function of capturing an image to generate image data using the device 10S (camera) and printing the image data by using the device 10V (multifunction device). The image capturing and printing function may be set in advance in the devices 10S and 10V used in the image capturing and printing function, in the devices 10A and 10P serving as relays, or in the requesting device 10F. The user may designate the devices 10S and 10V to be used for the image capturing and printing function when giving an instruction for executing the image capturing and printing function.

When an instruction is given by a user to execute the image capturing and printing function, the assistant control unit 22 selects the operation assistant A1 capable of interacting with the operation assistant A1 included in the device 10A connected to the device 10S from among the operation assistants A1 and A6 included in the requesting device 10F. The assistant control unit 22 transmits information indicating an operation instruction including an instruction for executing the image capturing and printing function from the selected operation assistant A1 to the operation assistant A1 included in the device 10A.

The operation assistant A1 included in the device 10A acquires image data generated by capturing an image with the device 10S from the device 10S in accordance with the operation instruction transmitted from the device 10F, and transmits the image data to the operation assistant A1 included in the device 10F. The image data is temporarily stored in the device 10F.

Then, the assistant control unit 22 selects the operation assistant A6 capable of interacting with the operation assistant A6 included in the device 10P connected to the device 10V from among the operation assistants A1 and A6 included in the requesting device 10F. The assistant control unit 22 transmits the information indicating an operation instruction including an instruction for executing the image capturing and printing function and the image data acquired from the device 10S from the selected operation assistant A6 to the operation assistant A6 included in the device 10P.

The operation assistant A6 included in the device 10P transmits the image data transmitted from the device 10F to the device 10V in accordance with the operation instruction transmitted from the device 10F, and causes the device 10V to print the image data. The device 10V prints the image data.

According to Example 2-7, also when a collaborative function is executed by using a plurality of devices 10, the user operating the requesting device 10 may be able to give an instruction for executing a collaborative function without being aware of operation assistants included the devices 10.

In the example illustrated in FIG. 23, a plurality of relays (the devices 10A and 10P) are used. Alternatively, a single relay may be used. For example, as illustrated in FIG. 24, the device 10A is used as a relay. The device 10A includes the operation assistants A1 and A6.

When an instruction is given by a user to execute the image capturing and printing function, the assistant control unit 22 transmits information indicating an operation instruction including an instruction for executing the image capturing and printing function from the operation assistant A1 included in the requesting device 10F to the operation assistant A1 included in the device 10A.

The operation assistant A1 included in the device 10A acquires image data generated by capturing an image from the device 10S and transmits the image data to the operation assistant A1 included in the device 10F. The image data is temporarily stored in the device 10F.

Then, the assistant control unit 22 transmits information indicating an operation instruction including an instruction for executing the image capturing and printing function and the image data acquired from the device 10S from the operation assistant A6 included in the requesting device 10F to the operation assistant A6 included in the device 10A.

The operation assistant A6 included in the device 10A causes the device 10V to print the image data in accordance with the operation instruction transmitted from the device 10F.

The operation assistant A1 included in the device 10A may not necessarily transmit the image data acquired from the device 10S to the device 10F. In this case, the operation assistant A6 included in the device 10A may transmit the image data to the device 10V and cause the device 10V to print the image data.

In Examples 2-5, 2-6, and 2-7 described above, when an operation assistant fails to provide an instruction for executing a function to the operation target device 10, the control unit 20 may control notification of a reason for the failure to provide the instruction. For example, in some cases, an operation assistant may not support the target function to be executed and may fail to provide an instruction for executing the function to the device 10 depending on the version of the operation assistant. In addition, in some cases, a function controllable by an operation assistant may be limited, and due to the limitation, the operation assistant may fail to provide an instruction for executing the function to the device 10. Additionally, in some cases, a function available to a user account that is currently logged into an operation assistant may be limited, and due to the limitation, the operation assistant may fail to provide an instruction for executing the function to the device 10. Moreover, in some cases, a standard operation assistant may not support the target function to be executed. For example, a standard operation assistant, which has a common function included in a plurality of types of operation assistants, may not have other functions or may have other functions that are low in performance. In such a case, the standard operation assistant may fail to provide an instruction for executing a function to the operation target device 10.

The factors that may cause the issues described above may occur in an operation assistant included in the requesting device 10, an operation assistant included in the requested device 10, or operation assistants included in both the requesting device 10 and the requested device 10. In any case, an instruction for executing a function fails to be provided to the device 10. In this case, the control unit 20 controls notification of a reason for the failure to provide the instruction to the device 10.

For example, the requesting device 10 provides a notification of the reasons described above. The control unit 20 of the requesting device 10 may display information indicating the reasons on a display unit of the UI unit 14 of the requesting device 10 or may output the information via audio.

For example, when an instruction for executing a function fails to be provided to the operation target device 10 because the version of an operation assistant does not support the target function to be executed, the control unit 20 provides a notification of information indicating that the version of the operation assistant does not support the target function to be executed.

When an instruction for executing a function fails to be provided to the operation target device 10 because a function controllable by the operation assistant is limited, the control unit 20 provides a notification of information indicating that there is a limitation on the function controllable by the operation assistant.

When an instruction for executing a function fails to be provided to the operation target device 10 because a function available to a user account is limited, the control unit 20 provides a notification of information indicating that there is a limitation on the function available to the user account.

When an instruction for executing a function fails to be provided to the operation target device 10 because a standard operation assistant does not support the target function to be executed, the control unit 20 provides a notification of information indicating that the standard operation assistant does not support the target function to be executed.

The notifications described above enable a user to be notified of the reason for the failure to provide an instruction for executing a function to the device 10.

Further, when the requesting device 10, the requested device 10, or a relay does not include an operation assistant capable of providing an instruction for executing the target function to be executed to the operation target device 10, an instruction for executing the function fails to be provided to the operation target device 10. In this case, the control unit 20 may provide a notification of a reason for the failure to provide an instruction for executing the function to the operation target device 10. For example, the control unit 20 provides a notification of information indicating that the requesting device 10, the requested device 10, or a relay does not include an operation assistant capable of providing an instruction for executing a target function to be executed to the operation target device 10. This may enable a user to be notified of the reason for the failure to provide an instruction for executing a function to the device 10.

### Third Exemplary Embodiment

The following describes an information processing system according to a third exemplary embodiment of the present disclosure. Similarly to the information processing system according to the first exemplary embodiment, the information processing system according to the third exemplary embodiment includes one or more devices 10. Further, the device 10 according to the third exemplary embodiment has the same or substantially the same configuration as that of the device 10 according to the first exemplary embodiment.

In the third exemplary embodiment, the requested device 10 includes a plurality of operation assistants and is further connected to another device 10. When information indicating an operation instruction is transmitted from the requesting device 10 to the requested device 10, the assistant control unit 22 selects an operation assistant capable of controlling the other device 10 from among the plurality of operation assistants. The operation assistant controls the other device 10 in accordance with the operation instruction.

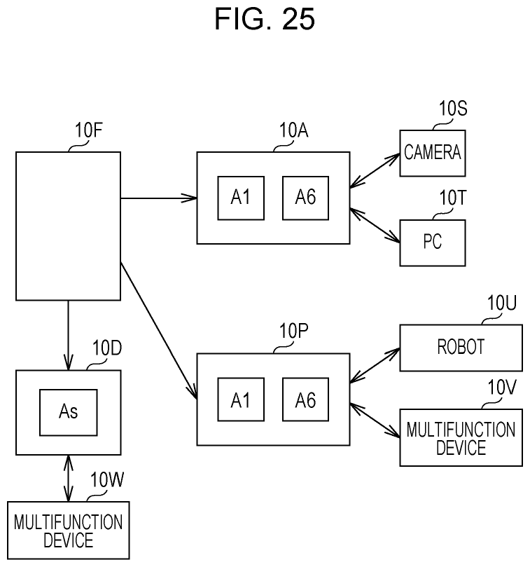

The following describes a process according to the third exemplary embodiment in detail with reference to FIG. 25. FIG. 25 illustrates an example of the devices 10. As an example, the device 10F corresponds to the requesting device, and the devices 10A, 10P, and 10D correspond to requested devices.

The devices 10A and 10P include the operation assistants A1 and A6. The device 10D includes the standard operation assistant As. Further, the device 10A is connected to the devices 10S and 10T as third devices. The device 10P is connected to the devices 10U and 10V as third devices. The device 10D is connected to a device 10W as a third device. The devices 10A, 10P, and 10D are used as relays.

Each of the devices 10F, 10S, 10T, 10U, 10V, and 10W may or may not include an operation assistant.

The device 10S is a device corresponding to the operation assistants A1, A2, and A3. That is, the device 10S is a device controllable by each of the operation assistants A1, A2, and A3. The device 10S is connected to the device 10A and is controlled by the operation assistant A1 included in the device 10A.

The device 10T is a device corresponding to the operation assistants A2 and A6. That is, the device 10T is a device controllable by each of the operation assistants A2 and A6. The device 10T is connected to the device 10A and is controlled by the operation assistant A6 included in the device 10A.

The device 10U is a device corresponding to the operation assistants A2 and A6. That is, the device 10U is a device controllable by each of the operation assistants A2 and A6. The device 10U is connected to the device 10P and is controlled by the operation assistant A6 included in the device 10P.

The device 10V is a device corresponding to the operation assistant A6. That is, the device 10V is a device controllable by the operation assistant A6. The device 10V is connected to the device 10P and is controlled by the operation assistant A6 included in the device 10P.

The device 10W is a device corresponding to the operation assistants A1, A3, and As. That is, the device 10W is a device controllable by the operation assistants A1, A3, and As. The device 10W is connected to the device 10D and is controlled by the operation assistant As included in the device 10D.

For example, when information indicating an operation instruction directed to the device 10S is transmitted from the device 10F to the device 10A, the assistant control unit 22 of the device 10A selects the operation assistant A1 capable of controlling the device 10S from among the operation assistants A1 and A6 included in the device 10A. The selected operation assistant A1 controls the device 10S in accordance with the operation instruction. For example, when the operation instruction includes an instruction for acquiring image data generated by capturing an image with the device 10S, the operation assistant A1 acquires image data from the device 10S and transmits the image data to the device 10F. For example, the assistant control unit 22 executes an operation assistant program for the operation assistant A1 to activate the operation assistant A1, and causes the operation assistant A1 to perform an operation according to the operation instruction. Further, the assistant control unit 22 may finish execution of an operation assistant program for the operation assistant A6 to complete activation of the operation assistant A6. It is to be understood that the operation assistant programs for both the operation assistants A1 and A6 may be executed. In this case, the assistant control unit 22 selects the operation assistant A1 and causes the operation assistant A1 to perform an operation according to the operation instruction.

When information indicating an operation instruction directed to the device 10V is transmitted from the device 10F to the device 10P, the assistant control unit 22 of the device 10P selects the operation assistant A6 capable of controlling the device 10V from among the operation assistants A1 and A6 included in the device 10P. The selected operation assistant A6 controls the device 10V in accordance with the operation instruction. For example, when the operation instruction includes an instruction for performing printing using the device 10V, the operation assistant A6 acquires image data to be printed from a storage location where the image data is stored (such as from the device 10F) and transmits the image data to the device 10V to cause the device 10V to print the image data.

When information indicating an operation instruction directed to the device 10W is transmitted from the device 10F to the device 10D, the assistant control unit 22 of the device 10D causes the standard operation assistant As capable of controlling the device 10W to perform an operation according to the operation instruction.

The assistant control unit 22 may select an operation assistant capable of controlling the target function to be executed and cause the operation assistant to control the function. For example, when a controllable function is limited for each operation assistant, the assistant control unit 22 selects an operation assistant capable of controlling the target function to be executed.

The assistant control unit 22 may select the operation assistant on the basis of the number of controllable devices. For example, the assistant control unit 22 may select an operation assistant capable of controlling the operation target device and capable of controlling the largest number of devices and may cause the operation assistant to perform an operation according to the operation instruction.

The assistant control unit 22 may select the operation assistant on the basis of the number of controllable functions. For example, the assistant control unit 22 may select an operation assistant capable of controlling the target function to be executed and capable of controlling the largest number of functions and may cause the operation assistant to perform an operation according to the operation instruction.

According to the third exemplary embodiment, even when the requested device 10 includes a plurality of operation assistants, an operation assistant capable of controlling the operation target device or the target function to be executed is selected, and the device or function is controlled by the operation assistant. This may allow the user operating the requesting device 10 to give an operation instruction without being aware of the operation assistants.

### Fourth Exemplary Embodiment

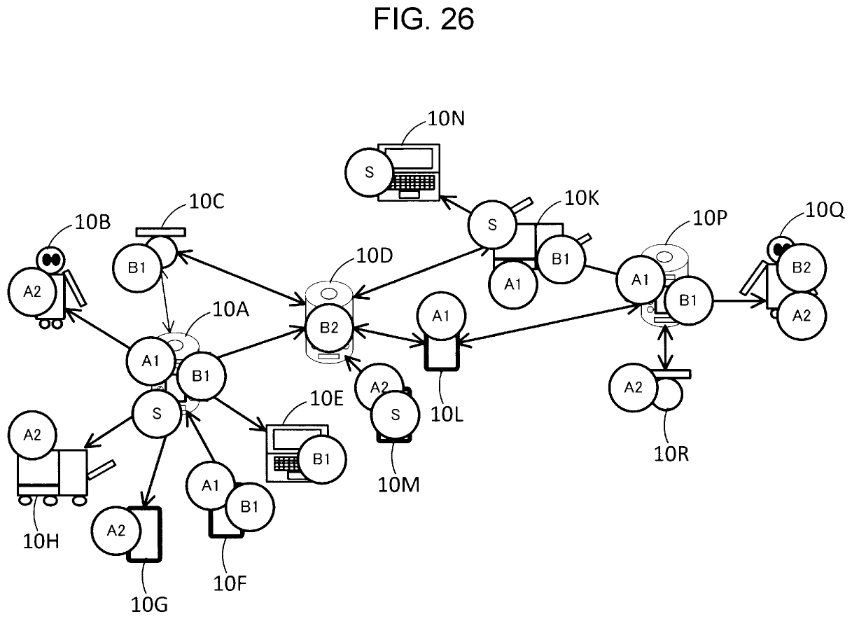

The following describes an information processing system according to a fourth exemplary embodiment of the present disclosure. FIG. 26 illustrates an example of the information processing system according to the fourth exemplary embodiment. Similarly to the information processing system according to the first exemplary embodiment, the information processing system according to the fourth exemplary embodiment includes devices 10A to 10R.

Each of the devices 10 includes one or more types of operation assistants. Some of the devices 10 may include an operation assistant having a user account set therein. An operation assistant having a user account set therein operates in accordance with an instruction from a user logging into the operation assistant using the user account, but does not operate in accordance with an instruction from any other user.

In the fourth exemplary embodiment, types of operation assistants are represented by symbols “A”, “B”, and “S”, for example, and user accounts are represented by numerals “1” and “2”, for example.

For example, a plurality of operation assistants of an identical type are operation assistants that operate in accordance with programs for operation assistants of an identical type, and operation assistants of different types are operation assistants that operate in accordance with programs for operation assistants of different types. For example, the operation assistants A1 and A2 operate in accordance with programs for operation assistants of an identical type. The same applies to operation assistants B1 and B2. The operation assistants A1 and B1 operate in accordance with programs for operation assistants of different types.

The term “identical type” may be used to indicate that operation assistants or programs have the same content or may be used to indicate that only the versions of operation assistants or programs are different.

For example, the operation assistants A1 and A2 are operation assistants of an identical type “A” (e.g., operation assistants that operate in accordance with the same program for operation assistant), but have different user accounts set therein. For example, the operation assistant A1 has set therein user account “1”, and the operation assistant A2 has set therein user account “2”. That is, the operation assistant A1 operates in accordance with an instruction from a user logging into the operation assistant A1 using the user account “1” and does not operate in accordance with an instruction from any other user. For example, the operation assistant A1 does not operate in accordance with an instruction from a user having the user account “2”. The same applies to the operation assistant A2. The same also applies to operation assistants of the type “B”.

An operation assistant S is a standard operation assistant also described in the first exemplary embodiment described above. The definition of the standard operation assistant is the same as that described in the first exemplary embodiment. The operation assistant S operates in accordance with an instruction from any user regardless of the user account.

As illustrated in FIG. 26, in some cases, the plurality of devices 10 may include operation assistants of an identical type or operation assistants having set therein an identical user account. In such cases, even if a user designates an operation assistant and gives an instruction via voice or the like, to which operation assistant the instruction is given and which of the devices 10 includes the operation assistant are difficult to specify only on the basis of the instruction. For example, an operation assistant has an audio identifying function. In this case, even if a user produces, by speech, assistant identification information for identifying the operation assistant A1, the operation assistant A1 is included in the devices 10A, 10F, 10L, and so forth, and thus, it is difficult to specify to which of the operation assistants A1 included in the devices 10 the instruction is given. Further, if no user account is specified, it is difficult to specify to which of the operation assistants A1 and A2 the instruction is given.

Further, when an operation assistant included in a certain device 10 transmits a connection request to an operation assistant included in another device 10, it may be difficult to specify from which operation assistant the connection request has been provided to the operation assistant included in the other device 10.

In the fourth exemplary embodiment, to address the issues described above, information indicating a connection request includes at least one of device identification information for identifying a device 10 that sends the connection request and assistant identification information for identifying an operation assistant included in the device 10. In a device 10 that has received the information indicating a connection request, the assistant control unit 22 specifies a device 10 and an operation assistant from which the information indicating a connection request has been transmitted to the device 10, on the basis of the identification information included in the information indicating a connection request. This enables the assistant control unit 22 of the device 10 that has received the connection request to specify a device 10 that has sent the connection request and an operation assistant included in the device 10. The specifying process may be performed by an operation assistant included in the device 10 that has received the connection request.

The following describes the fourth exemplary embodiment in detail.

### EXAMPLE 4-1

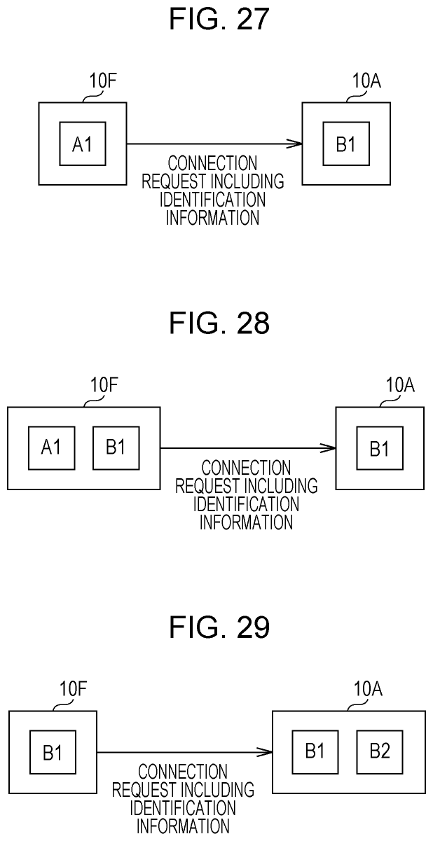

A process according to Example 4-1 will be described with reference to FIG. 27. FIG. 27 illustrates an example of the devices 10. As an example, the device 10F corresponds to the requesting device, and the device 10A corresponds to the requested device.

The device 10F includes the operation assistant A1, and the device 10A includes the operation assistant B1. The device 10F corresponds to an example of a first device, and the device 10A corresponds to an example of a second device. Further, the operation assistant A1 corresponds to an example of a first operation assistant, and the operation assistant B1 corresponds to an example of a second operation assistant.

For example, when a user makes a connection request directed to the device 10A by using the device 10F, the assistant control unit 22 of the device 10F creates information indicating a connection request, which includes device identification information of the device 10F and assistant identification information of the operation assistant A1. The device 10F transmits the information indicating a connection request to the device 10A.

As in the first exemplary embodiment described above, the assistant control unit 22 of the device 10F sets the operation assistant A1 included in the device 10F as a master operation assistant.

Further, the assistant control unit 22 of the device 10A checks whether the information indicating a connection request, which is transmitted from the device 10A, includes identification information. If the information indicating a connection request includes device identification information, the assistant control unit 22 of the device 10A specifies, on the basis of the device identification information, the device 10F that has transmitted the information indicating a connection request to the device 10A. This allows the assistant control unit 22 of the device 10A to specify the device 10F to which a response is sent. When the information indicating a connection request includes assistant identification information, the assistant control unit 22 of the device 10A specifies, on the basis of the assistant identification information, the operation assistant A1 included in the device 10F that has transmitted the information indicating a connection request. This allows the assistant control unit 22 of the device 10A to specify the operation assistant A1 included in the device 10F as an operation assistant with which the operation assistant B1 included in the device 10A exchanges information.

As described above, the device 10A specifies, as the device 10F, the device 10 that has transmitted the information indicating a connection request to the device 10A. In addition, the device 10A specifies, as the operation assistant A1, the operation assistant with which the operation assistant B1 included in the device 10A is to exchange information.

Further, when the information indicating a connection request includes at least one of device identification information and assistant identification information, the assistant control unit 22 of the device 10A sets the operation assistant B1 included in the device 10A as a slave operation assistant that operates in accordance with an instruction from the operation assistant A1 included in the device 10F.

Accordingly, as in the first exemplary embodiment, the operation assistant A1 included in the requesting device 10F is set as a master operation assistant, and the operation assistant B1 included in the requested device 10A is set as a slave operation assistant. As described above, the operation assistant A1 included in the device 10F, which has made a connection request, is specified. Thus, the operation assistant B1 may be able to exchange information with the operation assistant A1 included in the device 10F, which has made a connection request.

As described above, information is exchanged between the operation assistant A1 included in the device 10F serving as the master operation assistant and the operation assistant B1 included in the device 10A serving as the slave operation assistant. The operation assistant B1 operates in accordance with an instruction from the operation assistant A1.

When the information indicating a connection request does not include either device identification information or assistant identification information, the assistant control unit 22 of the device 10A does not set the operation assistant B1 included in the device 10A as a slave operation assistant.

According to Example 4-1, when information indicating a connection request includes identification information, the requested device 10 may be able to specify the requesting device 10 and an operation assistant included in the device 10 (the interaction partner of an operation assistant included in the requested device 10). In addition, it may be possible to establish a master-slave relationship between the operation assistant included in the requesting device 10 and the operation assistant included in the requested device 10.

Note that when information indicating a connection request includes device identification information, but does not include assistant identification information, the assistant control unit 22 of the requested device 10A specifies the requesting device 10F on the basis of the device identification information. In this case, if the requested device 10A has not specified an operation assistant included in the requesting device 10F, the operation assistant B1 included in the device 10A exchanges information with the undefined operation assistant included in the specified device 10F. During the exchange of the information, the device 10A may specify the operation assistant A1 included in the device 10F.

When the information indicating a connection request includes assistant identification information, but does not include device identification information, the assistant control unit 22 of the requested device 10A specifies the operation assistant A1 as the interaction partner on the basis of the assistant identification information. In this case, if the requested device 10A has not specified the requesting device 10F, the operation assistant B1 included in the device 10A exchanges information with the specified operation assistant A1. During the exchange of the information, the device 10A may specify the device 10F including the operation assistant A1.

When the information indicating a connection request includes no identification information, the assistant control unit 22 does not establish a master-slave relationship between an operation assistant included in the requesting device 10F and an operation assistant included in the requested device 10A. That is, the requested device 10A has not specified the requesting device 10F and an operation assistant as the interaction partner, and thus it may be difficult for the operation assistant included in the requested device 10A to specify to which of the devices 10 or which operation assistant to transmit information. In this situation, there is no technical significance for setting the operation assistant included in the requested device 10A as a slave operation assistant. Thus, the assistant control unit 22 does not establish a master-slave relationship.

The assistant control unit 22 of the requesting device 10F may create information indicating a connection request, which does not include device identification information of the device 10F but includes assistant identification information of the operation assistant A1. The created information indicating a connection request is transmitted from the device 10F to the requested device 10A. The assistant control unit 22 of the requested device 10A specifies, on the basis of the assistant identification information, the operation assistant A1 as the interaction partner of the operation assistant B1. When one device 10 is placed near the requested device 10A and includes a single operation assistant A1, the assistant control unit 22 of the device 10A is able to identify, on the basis of the received assistant identification information, the operation assistant A1 included in the device 10 as an operation assistant (i.e., the master operation assistant) that is the interaction partner of the operation assistant B1. Further, even when a plurality of devices 10 are placed near the requested device 10A, when only one of the plurality of devices 10 includes a single operation assistant A1, the assistant control unit 22 of the device 10A is able to identify, on the basis of the received assistant identification information, the operation assistant A1 included in the one device 10 as the master operation assistant and to identify the one device 10 as the requesting device 10. Accordingly, even if information indicating a connection request includes no device identification information, the requested device 10A may be able to specify the requesting device 10F and the master operation assistant.

The assistant control unit 22 of the requesting device 10F may create information indicating a connection request, which includes device identification information of the device 10F but does not include assistant identification information of the operation assistant A1. The created information indicating a connection request is transmitted from the device 10F to the requested device 10A. The assistant control unit 22 of the requested device 10A specifies the requesting device 10F on the basis of the device identification information. When the requesting device 10F includes only one operation assistant, the assistant control unit 22 of the device 10F specifies the one operation assistant as the master operation assistant. The operation assistant B1 included in the device 10F identifies the one operation assistant as the master operation assistant and exchanges information with the one operation assistant. Accordingly, even if the information indicating a connection request includes no assistant identification information, the requested device 10A may be able to specify the requesting device 10F and the master operation assistant.

### EXAMPLE 4-2

A process according to Example 4-2 will be described with reference to FIG. 28. FIG. 28 illustrates an example of the devices 10. As an example, the device 10F corresponds to the requesting device, and the device 10A corresponds to the requested device.

The device 10F includes the operation assistants A1 and B1, and the device 10A includes the operation assistant B1. The device 10F corresponds to an example of a first device, and the device 10A corresponds to an example of a second device. Further, the operation assistant A1 or the operation assistant B1 included in the device 10F corresponds to an example of a first operation assistant, and the operation assistant B1 included in the device 10A corresponds to an example of a second operation assistant.

The assistant control unit 22 of the requesting device 10F determines an operation assistant that operates as a master operation assistant among the operation assistants A1 and B1 included in the device 10F. For example, the assistant control unit 22 may determine the master operation assistant in accordance with an instruction given by a user who uses the device 10F or may determine, as described below, an operation assistant mainly operating in the device 10F as the master operation assistant. It is assumed here that the operation assistant A1 is determined as the master operation assistant.

The assistant control unit 22 of the device 10F creates information indicating a connection request, which includes device identification information of the device 10F and assistant identification information of the operation assistant A1. The device 10F transmits the information indicating a connection request to the device 10A.

The assistant control unit 22 of the device 10F sets the operation assistant A1 included in the device 10F as a master operation assistant in terms of the relationship with an operation assistant included in the requested device 10 and operating as a slave operation assistant.

Further, as in Example 4-1, the assistant control unit 22 of the device 10A checks whether the information indicating a connection request, which is transmitted from the device 10F, includes identification information. If the information indicating a connection request includes device identification information, the assistant control unit 22 of the device 10A specifies, on the basis of the device identification information, the device 10F that has transmitted the information indicating a connection request to the device 10A. This enables the assistant control unit 22 of the device 10A to specify the device 10F to which a response is sent. When the information indicating a connection request includes assistant identification information, the assistant control unit 22 of the device 10A specifies, on the basis of the assistant identification information, the operation assistant A1 included in the device 10F that has transmitted the information indicating a connection request and identifies the operation assistant A1 as a master operation assistant. This enables the assistant control unit 22 of the requested device 10A to specify, when the requesting device 10F includes a plurality of operation assistants, the operation assistant A1 included in the device 10F as a master operation assistant with which the operation assistant B1 included in the device 10A exchanges information.

Further, as Example 4-1, the assistant control unit 22 of the device 10A sets the operation assistant B1 included in the device 10A as a slave operation assistant that operates in accordance with an instruction from the operation assistant A1 included in the device 10F.

As described above, information is exchanged between the operation assistant A1 included in the device 10F serving as the master operation assistant and the operation assistant B1 included in the device 10A serving as the slave operation assistant. The operation assistant B1 operates in accordance with an instruction from the operation assistant A1.

According to Example 4-2, even when the requesting device 10 includes a plurality of operation assistants, the requested device 10 may be able to specify a master operation assistant as the interaction partner of an operation assistant included in the requested device 10 and operating as a slave operation assistant. In addition, it may be possible to establish a master-slave relationship between the operation assistant included in the requesting device 10 and the operation assistant included in the requested device 10.

When the information indicating a connection request includes no identification information, as in Example 4-1, the master-slave relationship described above is not established.

### EXAMPLE 4-3

A process according to Example 4-3 will be described with reference to FIG. 29. FIG. 29 illustrates an example of the devices 10. As an example, the device 10F corresponds to the requesting device, and the device 10A corresponds to the requested device.

The device 10F includes the operation assistant B1, and the device 10A includes the operation assistants B1 and B2. The device 10F corresponds to an example of a first device, and the device 10A corresponds to an example of a second device. Further, the operation assistant B1 included in the device 10F corresponds to an example of a first operation assistant, and the operation assistant B1 or B2 included in the device 10A corresponds to an example of a second operation assistant.

The assistant control unit 22 of the device 10F creates information indicating a connection request, which includes device identification information of the device 10F, assistant identification information of the operation assistant B1 included in the device 10F, and assistant identification information of an operation assistant to be enabled as a slave operation assistant. The device 10F transmits the created information indicating a connection request to the device 10A.

The operation assistant to be enabled as a slave operation assistant may be designated by, for example, a user who uses the device 10F or by using an operation assistant specifying method described below or any other method.

The assistant control unit 22 of the device 10F sets the operation assistant B1 included in the device 10F as a master operation assistant in terms of the relationship with an operation assistant included in the requested device 10 and operating as a slave operation assistant.

Further, as in Example 4-1, the assistant control unit 22 of the device 10A checks whether the information indicating a connection request, which is transmitted from the device 10F, includes identification information. If the information indicating a connection request includes device identification information, the assistant control unit 22 of the device 10A specifies, on the basis of the device identification information, the device 10F that has transmitted the information indicating a connection request to the device 10A. This enables the assistant control unit 22 of the device 10A to specify the device 10F to which a response is sent. When the information indicating a connection request includes assistant identification information of the operation assistant B1 included in the device 10F, the assistant control unit 22 of the device 10A specifies, on the basis of the assistant identification information, the operation assistant B1 included in the device 10F that has transmitted the information indicating a connection request and identifies the operation assistant B1 as a master operation assistant. When the information indicating a connection request includes assistant identification information of an operation assistant to be enabled as a slave operation assistant, the assistant control unit 22 of the device 10A specifies, on the basis of the assistant identification information, any one of the operation assistants B1 and B2 included in the device 10A as a slave operation assistant. For example, when the operation assistant B1 included in the device 10A is designated as an operation assistant to be enabled as a slave operation assistant, the assistant control unit 22 of the device 10A sets the operation assistant B1 as a slave operation assistant that operates in accordance with an instruction from the operation assistant B1 included in the device 10F.

As described above, information is exchanged between the operation assistant B1 included in the device 10F serving as the master operation assistant and the operation assistant B1 included in the device 10A serving as the slave operation assistant. The operation assistant B1 included in the device 10A operates in accordance with an instruction from the operation assistant A1 included in the device 10F.

According to Example 4-3, even when the requested device 10 includes a plurality of operation assistants, the requested device 10 may be able to specify an operation assistant that operates as a slave operation assistant. In addition, it may be possible to establish a master-slave relationship between the operation assistant included in the requesting device 10 and the operation assistant included in the requested device 10.

When the information indicating a connection request includes no identification information, as in Example 4-1, the master-slave relationship described above is not established.

### EXAMPLE 4-4

A process according to Example 4-4 will be described. In Example 4-4, when a plurality of operation assistants of an identical type and a plurality of devices 10 are located near a device 10 including a master operation assistant, the assistant control unit 22 of the device 10 including a master operation assistant specifies a device 10 that is to receive an instruction and a slave operation assistant on the basis of identification information. The term “near a device 10” refers to, for example, a range over which the device 10 supports communication or a predetermined range from the device 10.

For example, it is assumed that the device 10F including the operation assistant A1 transmits information indicating a connection request to another device 10 and that the operation assistant A1 included in the device 10F corresponds to the master operation assistant. The device 10F corresponds to an example of a first device.

The device 10F including the operation assistant A1 serving as the master operation assistant receives input of assistant identification information of a slave operation assistant that is to receive an instruction from the master operation assistant and device identification information of the device 10 including the slave operation assistant. The method of inputting the identification information described above will be described below.

The assistant control unit 22 of the device 10F identifies, on the basis of the assistant identification information input to the device 10F, an operation assistant that operates as a slave operation assistant, and specifies, on the basis of the device identification information input to the device 10F, the device 10 including the slave operation assistant. The device 10 including the slave operation assistant corresponds to an example of a second device.

As described above, when a slave operation assistant and a device 10 including the slave operation assistant are specified, information is exchanged between the operation assistant A1 included in the device 10F serving as the master operation assistant and the slave operation assistant. The slave operation assistant operates in accordance with an instruction from the operation assistant A1.

According to Example 4-4, even when a plurality of operation assistants of an identical type and a plurality of devices 10 are located near a device including the master operation assistant, it may be possible to specify a slave operation assistant and a device 10 including the slave operation assistant and to establish a master-slave relationship between the master operation assistant and the slave operation assistant.

### EXAMPLE 4-5

Example 4-5 will be described. When the device 10 includes a plurality of operation assistants, an operation assistant that operates as a master operation assistant and an operation assistant that operates as a sub-operation assistant may be determined among the plurality of operation assistants. Typically, the master operation assistant operates on the device 10 and responds to a request from a user. However, when a request or the like that is difficult for the master operation assistant to handle is provided to the master operation assistant, the sub-operation assistant operates in accordance with the request or the like. An idle operation assistant may be determined among the plurality of operation assistants. Here, the master operation assistant is not limited to the master operation assistant in a master-slave relationship between operation assistants, and is an operation assistant mainly operating in a device 10 including a plurality of operation assistants.

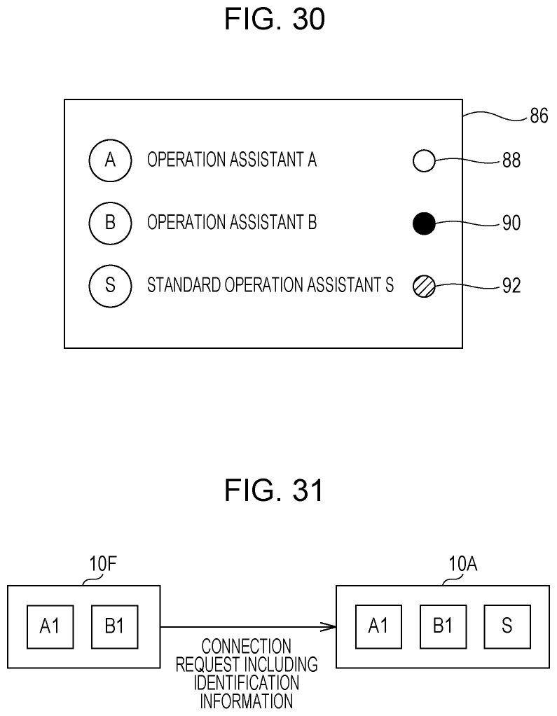

For example, a “master” or “sub” operation assistant is determined by a user. FIG. 30 illustrates a setting screen. The control unit 20 of the device 10 causes the UI unit 14 to display a setting screen 86 in accordance with an instruction given by a user and to display information for identifying operation assistants included in the device 10 on the setting screen 86. For example, a “master” or “sub” operation assistant included in the device 10A is assumed to be determined. The device 10A includes, for example, operation assistants A, B, and S. The setting screen 86 displays information (such as the name) for identifying each of the operation assistants A, B, and S. The setting screen 86 displays setting buttons 88, 90, and 92 corresponding to the operation assistants A, B, and S, respectively. A user is able to set a master operation assistant, a sub-operation assistant, and an idle operation assistant by operating the setting buttons 88, 90, and 92. For example, the operation assistant B is set as a master operation assistant, the standard operation assistant S is set as a sub-operation assistant, and the operation assistant A is set as an idle operation assistant. In the device 10A, accordingly, the operation assistant B typically performs various types of processing or control (such as processing for implementing a request from a user). In response to the occurrence of an issue that is difficult for the operation assistant B to handle, the standard operation assistant S addresses the issue. For example, when an instruction is provided to the device 10 to control a process or device that is uncontrollable by the operation assistant B, the standard operation assistant S operates in accordance with the instruction. In addition, the operation assistant A is idle in the device 10A.

The master operation assistant and the sub-operation assistant may be set in all of the devices 10 included in the information processing system, or the master operation assistant and the sub-operation assistant may be set in some of the devices 10. A plurality of sub-operation assistants may be set in the same device 10. In this case, the order of precedence of the plurality of operation assistants may be determined.

The master operation assistant and the sub-operation assistant may be set for each user account. That is, even the same operation assistant may be set as the master operation assistant for a certain user account and may be set as the sub-operation assistant for a different user account.

The following describes a process according to Example 4-5 with reference to FIG. 31. FIG. 31 illustrates an example of the devices 10. As an example, the device 10F corresponds to the requesting device, and the device 10A corresponds to the requested device.

The device 10F includes the operation assistants A1 and B1, and the device 10A includes the operation assistants A1, B1, and S. The device 10F corresponds to a first device, and the device 10A corresponds to a second device.

In the device 10F, the operation assistant A1 is determined as a master operation assistant, and the operation assistant B1 is determined as a sub-operation assistant. In the device 10A, the operation assistant A1 is determined as a master operation assistant, the operation assistant B1 is determined as a sub-operation assistant, and the standard operation assistant S is not in operation.

The assistant control unit 22 of the device 10F creates information indicating a connection request, which includes device identification information of the device 10F and assistant identification information of the operation assistant A1 operating as the master operation assistant in the device 10F. The device 10F transmits the information indicating a connection request to the device 10A.

The assistant control unit 22 of the device 10A checks whether the information indicating a connection request, which is transmitted from the device 10F, includes identification information. If the information indicating a connection request includes device identification information, the assistant control unit 22 of the device 10A specifies, on the basis of the device identification information, the device 10F that has transmitted the information indicating a connection request to the device 10A. This enables the assistant control unit 22 of the device 10A to specify the device 10F to which a response is sent. When the information indicating a connection request includes assistant identification information of the operation assistant A1 that operates as the master operation assistant in the device 10F, the assistant control unit 22 of the device 10A specifies, on the basis of the assistant identification information, the operation assistant A1 that is an operation assistant of a type identical to that of the operation assistant A1 and that operates as the master operation assistant in the device 10A from among the operation assistants A1, B1, and S included in the device 10A and identifies the operation assistant A1 as a slave operation assistant to the operation assistant A1.

The assistant control unit 22 of the device 10A sets the operation assistant A1 included in the device 10A as a slave operation assistant in terms of the relationship with the operation assistant A1 included in the device 10F. Further, the assistant control unit 22 of the device 10F sets the operation assistant A1 included in the device 10F as a master operation assistant in terms of the relationship with the operation assistant A1 included in the device 10A.

As described above, a master-slave relationship is established between the operation assistant A1 operating as the master operation assistant in the device 10F and the operation assistant A1 operating as the master operation assistant in the device 10A. The operation assistant A1 included in the device 10A operates as a slave operation assistant in the relationship with the operation assistant A1 included in the device 10F. Information is exchanged between the operation assistants described above, and the operation assistant A1 included in the device 10A operates in accordance with an instruction from the operation assistant A1 included in the device 10F.

The establishment of a master-slave relationship between the master operation assistant in the requesting device and the master operation assistant in the requested device, that is, exchanging of information between operation assistants that are mainly operating in both devices, may reduce the time taken for processing. For example, a login process of an operation assistant or switching between user accounts may no longer be necessary. The time taken for such a process is no longer necessary, resulting in a reduction in the time taken for processing.

In the example described above, a master-slave relationship is established between the master operation assistant in the requesting device and the master operation assistant in the requested device. As another example, a master-slave relationship may be established between the master operation assistant in the requesting device and the sub-operation assistant in the requested device, or a master-slave relationship may be established between the sub-operation assistant in the requesting device and the master operation assistant or sub-operation assistant in the requested device. The sub-operation assistant in the requesting device operates as a sub-operation assistant in the requesting device 10, but operates as a master operation assistant in the relationship with the master operation assistant or sub-operation assistant in the requested device.

For example, when the master operation assistant in the requesting device is performing another process, a master-slave relationship may be established between the sub-operation assistant in the requesting device and the master operation assistant or sub-operation assistant in the requested device. When the master operation assistant in the requested device is performing another process, a master-slave relationship may be established between the master operation assistant or sub-operation assistant in the requesting device and the sub-operation assistant in the requested device. When it is difficult to establish a master-slave relationship between master operation assistants, a master-slave relationship is established between the sub-operation assistant in the requesting device and the master operation assistant in the requested device. When it is also difficult to establish a master-slave relationship even between the sub-operation assistant in the requesting device and the master operation assistant in the requested device, a master-slave relationship is established between the sub-operation assistant in the requesting device and the master operation assistant in the requested device. Otherwise, when it is difficult to exchange information between the master operation assistant in the requesting device and the master operation assistant in the requested device, but when it is possible to exchange information between the master operation assistant in the requesting device and the sub-operation assistant in the requested device, a master-slave relationship may be established between the master operation assistant in the requesting device and the sub-operation assistant in the requested device. Likewise, when it is difficult to exchange information between the sub-operation assistant in the requesting device and the master operation assistant in the requested device, but when it is possible to exchange information between the sub-operation assistant in the requesting device and the sub-operation assistant in the requested device, a master-slave relationship may be established between the sub-operation assistant in the requesting device and the sub-operation assistant in the requested device.

### EXAMPLE 4-6

A process according to Example 4-6, namely, a process for specifying the device 10 and an operation assistant and a process for creating identification information, will be described. The processes described above may be applied to Examples described above.

For example, in some cases, a user may associate a name of an operation assistant, other than a common name, with the operation assistant. For example, operation assistant A may be named “Taro”. In this case, this name is used as assistant identification information of the operation assistant A, and the assistant control unit 22 specifies the operation assistant A on the basis of the name. For example, the information indicating a connection request includes assistant identification information indicating the name of a master operation assistant, and the assistant control unit 22 of the requested device 10 specifies the master operation assistant on the basis of the name. Further, when a user speaks the name of the operation assistant A, the assistant control unit 22 of the device 10, upon receipt of the speech, analyzes the speech and specifies the operation assistant A on the basis of the name. For example, when a user speaks the name of a certain operation assistant and information indicating any one of the master operation assistant or the slave operation assistant, the assistant control unit 22, upon receipt of the speech, analyzes the speech and specifies the operation assistant as the master operation assistant or the slave operation assistant on the basis of the name.

The assistant control unit 22 may specify a user who has given a connection request on the basis of biometric information of the user. Examples of the biometric information include voice information, fingerprint information, retina information, iris information, and a face image. For example, the assistant control unit 22 of the requesting device 10 specifies a user who uses the requesting device 10 on the basis of biometric information. The same applies to a user who uses the requested device 10.

The assistant control unit 22 may specify a device 10 by using identification information specific to the device 10. Examples of the identification information include the MAC address and IP address of the device 10. The identification information may be used to specify the requesting device 10 or to specify the requested device 10.

The assistant control unit 22 of the requesting device 10 may specify the requested device 10 or an operation assistant on the basis of at least any one of information indicating an operation to be performed by the device 10 or the operation assistant, information indicating the time at which the operation is to be performed, information indicating the location where the operation is to be performed, information indicating the device 10 or the operation assistant that is to perform the operation, information indicating the reason for which the operation is performed, and information indicating how the operation is to be performed. An operation assistant included in the requesting device 10 may ask a user questions to obtain information necessary to specify the requested device 10 and an operation assistant. An operation assistant included in the requesting device 10 may estimate the requested device 10 and an operation assistant on the basis of responses obtained from the user. When no response is obtained from the user or if the user stops questions being asked, the operation assistant included in the requesting device 10 may estimate the requested device 10 and an operation assistant on the basis of a limited number of responses.

An operation history of each of the devices 10 may be managed, and information indicating the operation history may be used as identification information. The information indicating the operation history of each of the devices 10 may be stored in the corresponding one of the devices 10, may be shared by the devices 10, or may be stored in a device such as a server. For example, the assistant control unit 22 of the requesting device 10 specifies, on the basis of the operation history of each of the devices 10, a most recently used device of a type identical to the type of a device designated by the user, as the requested device 10. For example, when a user asks a robot serving as one of the devices 10 to perform a process, the assistant control unit 22 of the requesting device 10 specifies a robot that has been used most recently (at the point in time closest to the current point in time) as the device 10 asked to perform the process (i.e., the requested device 10). A specific example will be described. It is assumed that the information processing system includes robots A and B and that the robot A has been most recently used. In this case, the assistant control unit 22 of the requesting device 10 specifies the robot A, which has been most recently used, as the requested device 10. The information indicating a connection request is transmitted from the requesting device 10 to the robot A. As another example, an operation assistant included in the requesting device 10 may ask the user which of the robots A and B is the requested device 10 and may specify the requested device 10 in accordance with a response from the user.

An operation history of an operation assistant included in each of the devices 10 may be managed, and information indicating the operation history may be used as identification information. The information indicating the operation history of each operation assistant may be stored in the corresponding one of the devices 10, may be shared by the devices 10, or may be stored in a device such as a server. For example, the assistant control unit 22 of the requesting device 10 specifies, on the basis of the operation history of each operation assistant, a most recently used operation assistant of a type identical to the type of an operation assistant designated as a master operation assistant by the user, as a master operation assistant. The assistant control unit 22 of the requesting or requested device 10 may specify a most recently used operation assistant of a type identical to the type of an operation assistant designated as a slave operation assistant by the user, as a slave operation assistant. As in the case of specifying the device 10, an operation assistant included in the requesting or requested device 10 may ask the user and specify a master operation assistant and a slave operation assistant in accordance with a response from the user.

A user may designate the operation target device 10, the target process to be executed, or the operation target software, without designating an operation assistant, and give a connection request to the requesting device 10. For example, the requesting device 10 searches for the operation target device 10 (e.g., the requested device 10), and, when the operation target device 10 includes an operation assistant, the requesting device 10 activates the operation assistant. The operation assistant controls the process corresponding to a request made by the user. The assistant control unit 22 of the requesting device 10 may search for a device 10 capable of performing the target process to be executed and activate an operation assistant included in the device 10. Accordingly, a user may be able to use an operation assistant for implementing the desired process without designating the operation assistant.

An imaging device such as a camera may capture an image of the face of a user, and the assistant control unit 22 of the requesting device 10 may detect the movement of the eyes of the user on the basis of the captured image and specify the operation target device 10 (e.g., the requested device 10) on the basis of the detection result. For example, a device 10 at which the eyes are pointing is specified as the operation target device 10. The imaging device may be included in the requesting device 10 or may be placed in a location other than the requesting device 10. The assistant control unit 22 may specify the operation target device 10 on the basis of the user's voice.

The assistant control unit 22 of the requesting device 10 may specify the operation target device 10 on the basis of the positional relationship between the devices 10. For example, the assistant control unit 22 specifies the device 10 placed at the position closest to the requesting device 10 as the operation target device 10. As another example, the assistant control unit 22 may specify the operation target device 10 on the basis of the orientation relative to the requesting device 10. For example, the assistant control unit 22 specifies a device 10 facing the requesting device 10 as the operation target device 10.

In the way described above, a device 10 and an operation assistant are specified, and identification information is created. The identification information used to specify each of the devices 10 or the operation assistants may include at least one of information indicating the type of the device 10, an identification number unique to the device 10, information indicating the position of the device 10, information indicating the name of the device 10, information indicating the name of the operation assistant, biometric information of the user (such as voice information and fingerprint information), information indicating a user account that is currently logged into the device 10 or the operation assistant, and information indicating an operation history of the device 10 or the operation assistant. The assistant control unit 22 may specify a requesting device 10, an operation assistant included in the requesting device 10, a requested device 10, and an operation assistant included in the requested device 10 on the basis of the at least one of the pieces of information described above.

### Other Exemplary Embodiments

Example 4-5 described above may be applied to the second exemplary embodiment. For example, the requesting device 10F includes the operation assistants A1 and B1. In the device 10F, the operation assistant A1 is set as a master operation assistant and the operation assistant B1 is set as a sub-operation assistant. In this case, the operation assistant A1 serving as the master operation assistant transmits an operation instruction to the requested device 10. When the operation assistant A1 does not have a function of controlling the requested device 10, the operation assistant B1 serving as the sub-operation assistant transmits an operation instruction to the requested device 10.

When the requested device 10 includes a plurality of operation assistants, one of the plurality of operation assistants may be set as a master operation assistant and another operation assistant may be set as a sub-operation assistant. For example, the requested device 10A includes the operation assistants A1 and B1. In the device 10A, the operation assistant A1 is set as a master operation assistant and the operation assistant B1 is set as a sub-operation assistant. In this case, the operation assistant A1 serving as the master operation assistant receives an operation instruction from the requesting device 10 and controls the process corresponding to the operation instruction. If the operation assistant A1 does not have a function of controlling the process corresponding to the operation instruction, the operation assistant B1 serving as the sub-operation assistant receives an operation instruction from the requesting device 10 and controls the process corresponding to the operation instruction.

Further, information is exchanged between the master operation assistant (e.g., the operation assistant A1) included in the requesting device 10F and the master operation assistant (e.g., the operation assistant A1) included in the requested device 10A. It is to be understood that, as in the fourth exemplary embodiment, information may be exchanged between the sub-operation assistant included in the requesting device 10F and the master operation assistant or sub-operation assistant included in the requested device 10F.

An idle operation assistant may be set in the requesting device 10, or an idle operation assistant may be set in the requested device 10.

In the exemplary embodiments described above, each user account may be implemented as a social network service (SNS) account. The SNS account may also be referred to as a social media account. For example, a user may perform a login to each of the devices 10 or an operation assistant using an SNS account. When an SNS account is registered as a user account common to a plurality of operation assistants, the SNS account may be used to perform a login to the plurality of operation assistants. The same applies to a plurality of devices 10.

Each of the devices 10 described above is implemented by causing hardware and software to cooperate with each other, as an example. Specifically, each of the devices 10 includes one or more processors such as a central processing unit (CPU) (not illustrated). The one or more processors read and execute a program stored in a storage device (not illustrated) to implement the functions of each unit of the device 10. The program is stored in the storage device through a recording medium such as a compact disc (CD) or a digital versatile disc (DVD) or through a communication path such as a network. As another example, each unit of each of the devices 10 may be implemented by, for example, hardware resources such as a processor, an electronic circuit, or an application specific integrated circuit (ASIC). The implementation may use a device such as a memory. As still another example, each unit of each of the devices 10 may be implemented by a digital signal processor (DSP) or a field programmable gate array (FPGA).

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a controller that, when an operation instruction directed to a device is given by a user, sends the operation instruction to the device from an operation assistant capable of controlling the device among a plurality of operation assistants included in the information processing apparatus.

2. The information processing apparatus according to claim 1, wherein the controller controls display of an image of the operation assistant capable of controlling the device.

3. The information processing apparatus according to claim 2, wherein the controller further controls notification of an operation result of the device in association with the image.

4. The information processing apparatus according to claim 1, wherein the device includes an operation assistant, and
wherein the operation assistant capable of controlling the device comprises an operation assistant capable of interacting with the operation assistant included in the device.

5. The information processing apparatus according to claim 4, wherein the operation assistant capable of interacting with the operation assistant included in the device comprises an operation assistant capable of exchanging messages with the operation assistant included in the device.

6. The information processing apparatus according to claim 4, wherein the operation assistant capable of interacting with the operation assistant included in the device comprises an operation assistant of a type identical to a type of the operation assistant included in the device.

7. The information processing apparatus according to claim 4, wherein when the operation assistant included in the device is an operation assistant capable of interacting with the plurality of operation assistants included in the information processing apparatus, the controller uses any one of the plurality of operation assistants included in the information processing apparatus as the operation assistant capable of controlling the device.

8. The information processing apparatus according to claim 1, wherein the operation assistant capable of controlling the device comprises an operation assistant capable of interacting with an operation assistant that is included in another device connected to the device and that is capable of controlling the device, and
wherein the operation instruction is provided to the device via the other device.

9. The information processing apparatus according to claim 8, wherein the other device includes a plurality of operation assistants, and
wherein the operation assistant capable of controlling the device comprises an operation assistant capable of interacting with an operation assistant that is an operation assistant among the plurality of operation assistants included in the other device and that is capable of controlling the device.

10. The information processing apparatus according to claim 1, wherein the controller sends the operation instruction from an operation assistant capable of controlling another device connected to the device among the plurality of operation assistants included in the information processing apparatus.

11. The information processing apparatus according to claim 1, wherein the operation instruction includes an instruction for executing a function to be executed by the device, and
wherein the operation assistant capable of controlling the device comprises an operation assistant capable of providing the instruction for executing the function to the device.

12. The information processing apparatus according to claim 11, wherein the device includes a plurality of operation assistants, and
wherein the operation assistant capable of controlling the device comprises an operation assistant capable of interacting with an operation assistant that is an operation assistant among the plurality of operation assistants included in the device and that is capable of controlling the function.

13. The information processing apparatus according to claim 11, wherein the operation assistant capable of controlling the device comprises an operation assistant capable of interacting with an operation assistant that is included in another device connected to the device and that is capable of controlling the function, and
wherein the operation instruction is provided to the device via the other device.

14. The information processing apparatus according to claim 11, wherein when the instruction for executing the function fails to be provided to the device, the controller controls notification of a reason for failure to provide the instruction for executing the function to the device.

15. The information processing apparatus according to claim 14, wherein when the operation assistant capable of providing the instruction for executing the function to the device is not among the plurality of operation assistants included in the information processing apparatus, the controller further controls notification of a reason for failure to provide the instruction for executing the function to the device.

16. The information processing apparatus according to claim 1, wherein the operation assistant capable of controlling the device comprises an operation assistant operating as a master operation assistant in the information processing apparatus.

17. The information processing apparatus according to claim 16, wherein the device includes a plurality of operation assistants, and
wherein the operation assistant capable of controlling the device exchanges information with an operation assistant operating as a master operation assistant in the device among the plurality of operation assistants included in the device.

18. The information processing apparatus according to claim 1, wherein the device includes a plurality of operation assistants, and
wherein when an operation assistant capable of exchanging information with the operation assistant capable of controlling the device is not an operation assistant operating as a master operation assistant in the device among the plurality of operation assistants included in the device, but is an operation assistant operating as a sub-operation assistant in the device among the plurality of operation assistants included in the device, the controller sends the operation instruction to the sub-operation assistant and controls the device.

19. A non-transitory computer readable medium storing a program causing a computer to execute a process for information processing, the process comprising:
when an operation instruction directed to a first device is given by a user by using a second device, providing the operation instruction to the first device from an operation assistant capable of controlling the first device among a plurality of operation assistants included in the second device.

20. An information processing apparatus comprising:
control means for, when an operation instruction directed to a device is given by a user, sending the operation instruction to the device from an operation assistant capable of controlling the device among a plurality of operation assistants included in the information processing apparatus.
